(19) United States
(12) Patent Application Publication
(10) Pub. No.: US 2026/0159739 A1
(43) Pub. Date: Jun. 11, 2026

(54) HYDRATE MATERIALS FOR THERMAL ENERGY STORAGE AND METHODS FOR USING

(71) Applicants: BATTELLE MEMORIAL INSTITUTE, Richland, WA (US); WASHINGTON STATE UNIVERSITY, Pullman, WA (US)

(72) Inventors: VIJAYAKUMAR MURUGESAN, West Richland, WA (US); AJAY S. KARAKOTI, Richland, WA (US); KAVIN CHAKRAVARTHY THANGARAJ, Pullman, WA (US)

(73) Assignees: BATTELLE MEMORIAL INSTITUTE, Richland, WA (US); WASHINGTON STATE UNIVERSITY, Pullman, WA (US)

(21) Appl. No.: 19/415,362

(22) Filed: Dec. 10, 2025

Related U.S. Application Data
(60) Provisional application No. 63/730,397, filed on Dec. 10, 2024.

(51) Int. Cl. C09K 5/06

(52) U.S. Cl. CPC C09K 5/063

(57) ABSTRACT

Embodiments provide thermochemical energy storage materials, methods and systems. Materials include organic or organometal material hydrates and corresponding anhydrates including isolate site hydrates like alendronate sodium trihydrate, channel associated hydrates like cromolyn sodium, and ion associated hydrates like ibuprofen sodium dihydrate, and nedocromil sodium. Preferred hydrates have hydrophobic backbones and hydrophilic sites or channels.

### RELATED APPLICATIONS

This application claims benefit of U.S. Patent Application No. 63/730,397 filed Dec. 10, 2024. This referenced application is hereby incorporated herein by reference in its entirety including appendices and items incorporated therein by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to thermal energy storage (TES) materials, methods, and systems, more particularly to thermochemical energy storage (TCES) materials and systems, and most particularly to such systems that include organic or organometallic hydrates and their anhydrate counterparts as TCES material wherein the hydrates are isolated site hydrates, channel associated hydrates, and/or ion associated hydrates such as ibuprofen sodium dihydrate.

### Background Information

Grid stability and resilience are essential for ensuring a reliable and continuous energy supply, safeguarding against disruptions, and maintaining the functionality of critical infrastructure in an increasingly demand-driven environment. The rapid growth of energy-intensive operations, particularly in data centers, is projected to significantly stress the electric grid over the coming years. With the surge of artificial intelligence and machine learning (AI/ML) models that require massive processing power, the electricity consumption of data centers is expected to double by 2030. Increasing demand during peak consumption risks significant energy supply-demand imbalances. To address this, efficient energy management strategies are crucial to store excess energy when available and release it during peak demand periods. Thermal energy storage (TES) systems can provide a practical solution by: (1) storing electric energy during off-peak hours in the form of usable heat and releasing it back to the grid during peak demand (heat to electricity system configuration), or (2) removing heat load from the grid by recovering residential and industrial waste heat such as that from data centers for residential heating and cooling applications (heat-to-heat system configuration). These systems can substantially enhance grid flexibility by decoupling the energy supply from demand.

Among different TES technologies, thermochemical energy storage (TCES) is particularly valued for targeting multiple operational temperature ranges through reversible chemical reactions. For low-to-intermediate temperature range applications, inorganic salt hydrates have been widely investigated. These hydrates store and release energy through reversible hydration-dehydration cycles, though issues such as deliquescence, corrosiveness, and pulverization compromise their long-term performance. Recent progress in ML-assisted discovery of novel known and hypothetical inorganic salt hydrates has identified both simple and complex anion salts that may be used in TCES systems. However, these newly identified theoretical salts are yet to be synthesized and validated. Moreover, the theoretical prediction of salts does not consider the kinetics of the hydration and dehydration processes and the effect of repeated movement of water molecules into and out of the lattice on their long-term structural and compositional stability. Issues like deliquescence and pulverization from volume changes remain unaddressed by current ML-enabled theoretical models.

Problems continue to persist with thermal energy storage (TES) materials and systems. Improvements are needed to address the above shortcoming and to make thermal energy storage more commercially practical. Thermal energy storage presents an alternate method of storing excess heat energy available from renewable sources and other sources such as, for example, solar, wind, geothermal, nuclear, waste industrial heat sources. TES can be used to fulfill domestic/industrial space and water heating and cooling applications. While electricity can be used for general heating and cooling applications, using electricity for space heating or cooling applications during peak hours is costly and puts additional strain on the grid during peak summer and winter periods. In particular, thermal energy storage systems can store thermal energy during the off-peak hours that can be used for space and water heating during the peak hours. However, most of the current thermal energy storage systems suffer from various drawbacks such as low capacity, low efficiency, and limited number of thermal cycles. The majority of these problems are related to the choice of materials used in these systems for energy storage. TES can be classified into three separate forms: (1) sensible heat storage (SHS) system that use mostly molten salts or ceramics to store and release heat, (2) latent heat storage (LHS) systems which use phase change materials for the purposes of storing and releasing heat, and lastly thermochemical energy storage (TCES) systems that store or release energy based on a chemical reaction.

The focus of embodiments of the present invention is on TCES systems which can also be classified based on the type of materials used. They can further be classified as sorption-based and reaction-based energy storage depending upon the mechanism of the action of energy storage. In reaction based TCES, salt hydrates have been considered as one of the most promising candidates for storing and releasing energy. These salt hydrates, which are inorganic salts, dehydrate and release water upon heating (endothermic reaction for energy storage). Upon rehydration, the salts change from their anhydrous form to a hydrated form accompanied by the release of thermal energy (exothermic reaction for energy release). Depending upon the hydration number and the energy with which the water molecules are bonded to the parent compound, inorganic salt hydrates operate within a temperature range of 50-300° C. Several salts have been researched along with field demonstrations being performed with the salts operating in a temperature range below 100° C., wherein the salts included materials such as sodium and magnesium sulfate, calcium and magnesium chloride, and strontium bromide and sodium sulfide. Similarly, calcium oxide and oxalate-based systems have been tried as TCES systems in high temperature range of 100-300° C.

Several types of inorganic salt hydrates have been found, researched, and theoretically predicted in the recent literature. However, they suffer from multiple problems such as for example:
(A) Deliquescence—Most useful inorganic salt hydrates absorb water and turn from solid to semi-solid or liquid phase upon hydration. These materials change particle size and material structure upon dehydration, use more energy for crystallization, and need additional materials to act as nucleating agents. Together these issues reduce the overall TES efficiency of the system.
(B) Pulverization—The hydration and dehydration cycles in inorganic salt hydrates are accompanied by phase changes or lattice expansion and contraction that result in amorphization of the materials after a limited number of cycles resulting in loss of water of crystallization which may lead to inactive material.
(C) Corrosive—Many of the inorganic salt hydrates are corrosive and require use of expensive corrosion resistant materials for system fabrication increasing the overall capital cost of installation.
(D) Toxicity—Many of inorganic salts are based on chlorides and bromides which have the potential to release toxic and corrosive gases (Br₂ and Cl₂) during their cyclic use.
(E) Lack of systems—There are limited number of inorganic salt hydrates that fulfill the requirements of a full TES system. A recent paper compared various available hydrate systems and only a handful of the existing and predicted materials can work as TCES materials.

A need exists for discovery and development of new TES materials and systems and particularly materials and systems that can address one or more of the above noted shortcomings.

One of the alternatives is to explore the use of organic or organometallic compounds for use as TES materials and more specifically as TCES materials. For example, pharmaceutical compounds with well-defined crystal structures have been known to form hydrates. About 30% of the pharmaceutical compounds exist primarily in the form of hydrates. Some of these hydrates store water molecules reversibly; however, detailed research correlating their reversible water storage capacity with their energy storage capacity has never been attempted.

Hydrates of pharmaceutical compounds can be classified based on how the water molecule is stored or interacts with the drug compound resulting in specific physical-chemical properties potentially making them useful for thermal energy storage.
(A) Isolated site hydrates store water molecules through van der Waals interactions with the polar groups of the drug molecules with no intermolecular interaction between the water molecules. This interaction is reflected in sharp dehydration endotherms and narrow weight loss ranges making them suitable for TES applications.
(B) Channel hydrates store water molecules owing to their unique crystal structure depicting long channels along a crystallographic axis that are appropriate for storing water molecules. Due to the narrow channel dimensions and proximity of water molecules they form hydrogen bonds with the adjacent water molecules resulting in broad weight loss range and broad endothermic isotherms. Since there is no interaction with the drug molecules the dehydration temperature of channel hydrates is lower than the isolated site hydrates. However, the advantages of such structures are that the water molecules can be removed without affecting the crystal structure during drying and rehydration cycles.
(C) Ion-associated hydrates are salts of drug molecules that contain ion-coordinated water. The water molecules interact strongly with the corresponding ion in the salt resulting in higher dehydration temperatures.

Depending upon the class of the drug hydrate, specific temperature ranges for TES applications can be targeted. Combing the large number of candidate drug hydrates with a large parametric space for tuning the interaction with water (by controlling the number and nature of polar functional groups in the drug design), several combinations of drug hydrates can emerge and can be useful for thermal energy storage.

### SUMMARY

To address, at least in part, the above noted problems, some embodiments of the invention incorporate TCES materials including isolated site hydrates, channel associated hydrates, and/or ion associated hydrates that include hydrophobic backbones along with hydrophilic sites or channels. Some embodiments of the invention provide storage and energy release from combined TCES and LHS reactions Where the LHS may be in the form of solid-to-solid phase changes while in others it may be in the form of solid-to-liquid and liquid-to-solid phase changes, while in still other embodiments both types of LHS reactions may occur.

Some embodiments of the invention are directed to pharmaceutical organic salt hydrates as a class of materials with exceptional performance for low-grade waste heat recovery. In particular, one embodiment uses ibuprofen sodium dihydrate (ISD) as an example organic hydrate. It exhibits a dehydration temperature range of 60-110° C. and a remarkable dehydration enthalpy of up to 59.5 kJ/mol (225 J/g) of water, ideally suited for capturing industrial and residential waste heat. Experiments, as presented hereafter, applied rigorous multimodal characterization, including thermogravimetric analysis, differential scanning calorimetry, in-situ FTIR, in-situ PXRD, and NMR and demonstrated ISD's superior thermal, chemical, and structural stability over 150 hydration-dehydration cycles, achieving an unprecedented cycling efficiency of ˜99.9%. Compared to conventional inorganic salt hydrates like strontium chloride hexahydrate and calcium oxalate monohydrate, ISD showcases enhanced durability without deliquescence or pulverization, even under high-humidity conditions. In-situ analyses confirm that the transition from ISD to ibuprofen sodium anhydrous (ISA) proceeds with structural reorganization, thereby combining the dehydration mechanism with phase transitions, resulting in higher energy storage capacity. Microstructural analyses reveal that repeated water intercalation and structural transitions aid in creating significant porosity that enhances water transport kinetics, further improving the hydration/dehydration performance. By combining the phase change and chemical dehydration mechanisms, ISD paves the way for designing a new class of organic salt hydrates, offering tunable properties to meet diverse thermal energy storage demands and supporting sustainable grid resilience.

FIG. 1 provides a schematic illustration of an energy storage and release process using ibuprofen sodium dihydrate as the TCES material according to some embodiments of the invention.

In a first aspect of the invention a thermochemical energy storage method, includes: (a) providing a mass comprising an organic or an organometallic hydrate/anhydrate compound with a hydrophobic backbone capable of reversibly storing water in at least one of hydrophilic channels or hydrophilic sites and releasing water wherein release of water occurs upon heating with at least a portion of heat energy stored in chemical bonds of the compound while rehydration results in an exothermic reaction releasing heat; (b) locating the mass in a chamber; (c) heating an at least partially hydrated mass of the compound using an external source of energy to cause at least partial dehydration of the compound so as to store energy in the chemical bonds of the compound; (d) holding the mass in the at least partially dehydrated state until the stored energy is to be used; (e) adding moisture to the at least partially dehydrated compound in a controlled manner to controllably release heat energy; and (f) repeating (c)-(e) a plurality of times in an energy storage and release cycle.

Numerous variations of the first aspect exist and include, for example: (1) the first aspect wherein the organic or organometallic hydrate compound includes an isolated site hydrate; (2) the first variation of the first aspect wherein the isolated site hydrate includes alendronate sodium trihydrate; (3) the first aspect wherein the organic or organometallic hydrate compound includes a channel associated hydrate; (4) the third variation of the first aspect wherein the channel associated hydrate includes at least one hydrate selected from the group consisting of: (I) cromolyn sodium hydrate and (II) ibuprofen sodium dihydrate; (5) the first aspect wherein the organic or organometallic hydrate/anhydrate compound includes an ion associated hydrate; (6) the fifth variation of the first aspect wherein the ion associated hydrate includes at least one hydrate selected from the group consisting of: (I) ibuprofen sodium dihydrate and (II) nedocromil sodium; (7) the first aspect or any of its first to sixth variations wherein the heating is produced via a source selected from the group consisting of (I) a renewable energy source, (II) waste heat from an industrial process, and (III) an energy production source when production capacity exceeds demand, and (IV) an energy production source used during off peak cost periods, and wherein released energy is used at a time or for a purpose selected from the group consisting of: (i) during peak cost periods to provide for space or water heating purposes thus reducing use of more costly energy for such purposes, and (ii) to provide space or water heating during periods of reduced renewable energy availability; (8) the first aspect or any of its first to seventh variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds; and (9) the first aspect or any of its first to eighth variations wherein a difference between a temperature for full dehydration and melting of the compound is selected from the group consisting of: (i) >30° C., (ii) >50° C., (iii) >70° C., and (iv) >80° C.

In a second aspect of the invention a thermochemical energy storage and release medium includes an organic or an organometallic hydrate/anhydrate compound with a hydrophobic backbone containing at least one of hydrophilic channels or hydrophilic sites.

Numerous variations of the second aspect exist and include, for example: (1) the second aspect wherein the organic or organometallic hydrate compound includes an isolated site hydrate; (2) the first variation of the second aspect wherein the isolated site hydrate includes alendronate sodium trihydrate; (3) the second aspect wherein the organic or organometallic hydrate compound includes a channel associated hydrate; (4) the fourth variation of the second aspect wherein the channel associated hydrate includes at least one hydrate selected from the group consisting of: (1) cromolyn sodium and (II) ibuprofen sodium dihydrate; and (5) the second aspect wherein the organic or organometallic hydrate/anhydrate compound includes an ion associated hydrate; (6) the fifth variation of the second aspect wherein the ion associated hydrate includes at least one hydrate selected from the group consisting of: (1) ibuprofen sodium dihydrate and (2) nedocromil sodium; (7) the second aspect or any of its first to sixth variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds; (8) the second aspect wherein the compound comprises a pharmaceutical hydrate.

In a third aspect of the invention a system for storing and releasing energy, includes: (a) a source of heat energy; (b) a heat storage compound including a hydrate/anhydrate compound having a hydrophobic backbone with at least one of hydrophilic channels or hydrophilic sites; (c) a hydration source; (d) at least one reaction chamber for transitioning the heat storage compound from a more hydrous lower energy storage state to a higher anhydrous energy storage state via absorption of energy from the source of heat energy at a first time, and for transitioning the compound from the higher anhydrous energy storage state to a lower more hydrous energy storage state via the hydration source to supply on demand energy at a second time; and (e) a controller for repeatedly operating the reaction chamber to store and release energy.

Numerous variations of the third aspect exist and include, for example: (1) the third aspect wherein the organic or organometallic hydrate compound includes an isolated site hydrate; (2) the first variation of the third aspect wherein the isolated site hydrate includes alendronate sodium trihydrate; (3) the first variation of the third aspect wherein the organic or organometallic hydrate compound includes a channel associated hydrate; (4) the fourth variation of the third aspect wherein the channel associated hydrate includes at least one hydrate selected from the group consisting of: (I) cromolyn sodium, and (II) ibuprofen sodium dihydrate; (5) the first variation of the third aspect wherein the organic or organometallic hydrate/anhydrate compound includes an ion associated hydrate; (6) the fifth variation of the third aspect wherein the ion associated hydrate includes at least one hydrate selected from the group consisting of: (I) ibuprofen sodium dihydrate and (II) nedocromil sodium; and (7) the third aspect or any of its first to sixth variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds

In a fourth aspect of the invention a thermochemical energy storage method, includes: (a) providing a mass including an organic or an organometallic hydrate/anhydrate compound with a hydrophobic backbone capable of reversibly storing water at at least one of hydrophilic channels or sites and releasing water wherein release of water occurs upon heating with at least a portion of heat energy stored in chemical bonds of the compound while rehydration results in an exothermic reaction releasing heat, and wherein the compound has a melting temperature that is higher than a dehydration temperature; (b) locating the mass in a chamber; (c) heating an at least partially hydrated compound using an external source of energy to cause at least partial dehydration of the compound so as to store energy in the chemical bonds of the compound and continuing to heat the compound such that at least partial melting of the compound occurs with additional latent heat energy being stored in the compound as a result of melting; (d) holding the mass in the at least partially dehydrated state until the stored energy is to be used; (e) adding moisture to the at least partially dehydrated compound; and (f) repeating (c)-(e) a plurality of times in an energy storage and release cycle.

Numerous variations of the fourth aspect exist and include, for example: (1) the fourth aspect wherein the holding of the mass also holds at least a portion of the mass in molten form until the energy is to be used; (2) the fourth aspect or its first variation wherein the moisture is added in a controlled manner so as to control the release of energy from the mass; (3) the fourth aspect or either of its first or second variations wherein the organic or organometallic hydrate/anhydrate compound includes at least one hydrate selected from the group consisting of: (I) an ion associated hydrate and (II) a channel hydrate, and (III) a combination of (I) and (II); (4) the third variation of the fourth aspect wherein the hydrate includes ibuprofen sodium dihydrate; (5) the fourth aspect or any of its first to fourth variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds.

In a fifth aspect of the invention a thermochemical energy storage method, includes: (a) providing a mass of a medium including an organic or an organometallic hydrate/anhydrate compound with a hydrophobic backbone capable of reversibly storing water at at least one of hydrophilic channels or hydrophilic sites and releasing water wherein release of water occurs upon dehydration with the chemical bonds of the drier compound storing more energy than a more hydrated form of the compound while rehydration results in an exothermic reaction releasing heat; (b) locating the mass in a chamber; (c) dehydrating an at least partially hydrated mass of the compound to cause at least partial removal of water from the compound so as to store energy in the chemical bonds of the compound; (d) holding the mass in the at least partially dehydrated state until the stored energy is to be used; (e) adding moisture to the at least partially dehydrated compound in a controlled manner to controllably release heat energy; and (f) repeating (c)-(e) a plurality of times in an energy storage and release cycle.

Numerous variations of the fifth aspect exist and include, for example: (1) the fifth aspect wherein the organic or organometallic hydrate compound includes an isolated site hydrate; (2) the first variation of the fifth aspect wherein the isolated site hydrate includes alendronate sodium trihydrate; (3) the fifth aspect wherein the organic or organometallic hydrate compound includes a channel associated hydrate; (4) the third variation of the fifth aspect wherein the channel associated hydrate includes at least one hydrate selected from the group consisting of: (1) cromolyn sodium hydrate and (II) ibuprofen sodium dihydrate; (5) the fifth aspect wherein the organic or organometallic hydrate/anhydrate compound includes an ion associated hydrate; (6) the fifth variation of the fifth aspect wherein the ion associated hydrate includes at least one hydrate selected from the group consisting of: (I) ibuprofen sodium dihydrate and (II) nedocromil sodium; (7) the fifth aspect or any of its first to sixth variations wherein dehydration occurs via heating; (8) the seventh variation of the fifth aspect wherein the heating is produced via a source selected from the group consisting of (I) a renewable energy source, (II) waste heat from an industrial process, and (III) an energy production source when production capacity exceeds demand, and (IV4) an energy production source used during off peak cost periods, and wherein released energy is used at a time or for a purpose selected from the group consisting of: (i) during peak cost periods to provide for space or water heating purposes thus reducing use of more costly energy for such purposes, and (ii) to provide space or water heating during periods of reduced renewable energy availability; (8) the fifth aspect or any of its first to sixth variations wherein dehydration occurs via exposure of the compound to a dry gas or dry relative humidity gas where the moisture content of the gas is sufficiently low to extract water from the compound; (9) the fifth aspect or any of its first to seventh variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds.

In a sixth aspect of the invention a system for storing and releasing energy, includes: (a) a dehydration source; (b) a mass of an energy storage medium including an organic or an organometallic hydrate/anhydrate compound with a hydrophobic backbone capable of reversibly storing water at at least one of hydrophilic channels or hydrophilic sites in the compound and releasing water wherein release of water occurs upon dehydration with the chemical bonds of the drier compound storing more energy than a more hydrated form of the compound while rehydration results in an exothermic reaction releasing heat; (c) a hydration source; (d) at least one reaction chamber for dehydrating an at least partially hydrated mass of the compound to cause at least partial removal of water when forming a more dehydrated compound so as to store energy in the chemical bonds of the compound at a first time, and for transitioning the more dehydrated compound to a more hydrated compound via the hydration source to supply on demand energy at a second time; and (e) a controller for repeatedly dehydrating and hydrating the compound in the reaction chamber to store and release energy.

Numerous variations of the sixth aspect exist and include, for example: (1) the sixth aspect wherein the organic or organometallic hydrate compound includes an isolated site hydrate; (2) the first variation of the sixth aspect wherein the isolated site hydrate includes alendronate sodium trihydrate; (3) the sixth aspect wherein the organic or organometallic hydrate compound includes a channel associated hydrate; (4) the third variation of the sixth aspect wherein the channel associated hydrate includes at least one hydrate selected from the group consisting of: (I) cromolyn sodium, and (II) ibuprofen sodium dihydrate; (5) the first variation of the sixth aspect wherein the organic or organometallic hydrate/anhydrate compound includes an ion associated hydrate; (6) the fifth variation of the sixth aspect wherein the ion associated hydrate includes at least one hydrate selected from the group consisting of: (I) ibuprofen sodium dihydrate and (II) nedocromil sodium; (7) the sixth aspect or any of its first to sixth variations wherein dehydration occurs via heating; (8) the seventh variation of the sixth aspect wherein the heating is produced via a source selected from the group consisting of (I) a renewable energy source, (II) waste heat from an industrial process, and (III) an energy production source when production capacity exceeds demand, and (IV) an energy production source used during off peak cost periods, and wherein released energy is used at a time or for a purpose selected from the group consisting of: (i) during peak cost periods to provide for space or water heating purposes thus reducing use of more costly energy for such purposes, and (ii) to provide space or water heating during periods of reduced renewable energy availability; (9) the sixth aspect or any of its first to sixth variations wherein dehydration occurs via exposure of the compound to a dry gas or dry relative humidity gas where the moisture content of the gas is sufficiently low to extract water from the compound; and (10) the sixth aspect or any of its first to ninth variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds.

In a seventh aspect of the invention a thermochemical energy storage method, includes: (a) providing a medium including at least one compound selected from the group consisting of: (A) alendronate sodium trihydrate, (B) cromolyn sodium, (C) ibuprofen sodium dihydrate, and (D) nedocromil sodium wherein the compound is capable of reversibly storing water and releasing water wherein release of water occurs upon dehydration of the compound with energy stored in chemical bonds of the compound while rehydration results in an exothermic reaction releasing heat energy; (b) locating a partially hydrated mass of the medium in a chamber; (c) dehydrating the at least partially hydrated mass to cause at least partial dehydration of the mass so as to store energy in the chemical bonds of the compound; (d) holding the compound in an at least partially dehydrated state until the stored energy is to be used; (e) adding moisture to the at least partially dehydrated compound to release heat energy; and (f) repeating (c)-(e) a plurality of times in an energy storage and release cycle.

Numerous variations of the seventh aspect exist and include, for example: (1) the seventh aspect wherein the organic or organometallic hydrate compound includes an isolated site hydrate; (2) the first variation of the seventh aspect wherein the isolated site hydrate includes alendronate sodium trihydrate; (3) the seventh aspect wherein the organic or organometallic hydrate compound includes a channel associated hydrate; (4) the third variation of the seventh aspect wherein the channel associated hydrate includes at least one hydrate selected from the group consisting of: (I) cromolyn sodium hydrate and (II) ibuprofen sodium dihydrate; (5) the seventh aspect wherein the organic or organometallic hydrate/anhydrate compound includes an ion associated hydrate; (6) the fifth variation of the seventh aspect wherein the ion associated hydrate includes at least one hydrate selected from the group consisting of: (I) ibuprofen sodium dihydrate and (II) nedocromil sodium; (7) the seventh aspect or any of its first to sixth variations wherein dehydration occurs via heating; (8) the seventh variation of the seventh aspect wherein the heating is produced via a source selected from the group consisting of (I) a renewable energy source, (II) waste heat from an industrial process, and (III) an energy production source when production capacity exceeds demand, and (IV) an energy production source used during off peak cost periods, and wherein released energy is used at a time or for a purpose selected from the group consisting of: (i) during peak cost periods to provide for space or water heating purposes thus reducing use of more costly energy for such purposes, and (ii) to provide space or water heating during periods of reduced renewable energy availability; (9) the seventh aspect or any of its first to sixth variations wherein dehydration occurs via exposure of the compound to a dry gas or dry relative humidity gas where the moisture content of the gas is sufficiently low to extract water from the compound; and (10) the seventh aspect or any of its first to seventh variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds.

In an eighth ninth aspect of the invention a thermochemical energy storage and release medium includes at least one compound selected from the group consisting of: (I) alendronate sodium trihydrate, (II) cromolyn sodium, (III) ibuprofen sodium dihydrate, and (IV) nedocromil sodium wherein the compound is capable of reversibly storing water and releasing water wherein release of water occurs upon dehydration of the compound with energy stored in chemical bonds of the compound while rehydration results in an exothermic reaction releasing heat energy.

In a ninth aspect of the invention a system for storing and releasing energy, includes: (a) a dehydration source; (b) an energy storage medium including at least one compound selected from the group consisting of: (A) alendronate sodium trihydrate, (B) cromolyn sodium, (C) ibuprofen sodium dihydrate, (D) nedocromil sodium; (c) a hydration source; (d) at least one reaction chamber for dehydrating an at least partially hydrated mass of the compound to cause at least partial removal of water when forming a more dehydrated compound so as to store energy in the chemical bonds of the compound at a first time, and for transitioning the more dehydrated compound to a more hydrated compound via the hydration source to supply on demand energy at a second time; and (e) a controller for repeatedly dehydrating and hydrating the compound in the reaction chamber to store and release energy.

Numerous variations of the ninth aspect exist and include, for example: (1) the ninth aspect wherein the organic or organometallic hydrate compound includes an isolated site hydrate; (2) the first variation of the ninth aspect wherein the isolated site hydrate includes alendronate sodium trihydrate; (3) the ninth aspect wherein the organic or organometallic hydrate compound includes a channel associated hydrate; (4) the third variation of the ninth aspect wherein the channel associated hydrate includes at least one hydrate selected from the group consisting of: (I) cromolyn sodium, and (II) ibuprofen sodium dihydrate; (5) the ninth aspect wherein the organic or organometallic hydrate/anhydrate compound includes an ion associated hydrate; (6) the fifth variation of the ninth aspect wherein the ion associated hydrate includes at least one hydrate selected from the group consisting of: (I) ibuprofen sodium dihydrate and (II) nedocromil sodium; (7) the ninth aspect or any of its first to sixth variations wherein dehydration occurs via heating; (8) the seventh variation of the ninth aspect wherein the heating is produced via a source selected from the group consisting of (i) a renewable energy source, (ii) waste heat from an industrial process, and (iii) an energy production source when production capacity exceeds demand, and (iv) an energy production source used during off peak cost periods, and wherein released energy is used at a time or for a purpose selected from the group consisting of: (I) during peak cost periods to provide for space or water heating purposes thus reducing use of more costly energy for such purposes, and (II) to provide space or water heating during periods of reduced renewable energy availability; (9) the ninth aspect or any of its first to sixth variations wherein dehydration occurs via exposure of the compound to a dry gas or dry relative humidity gas where the moisture content of the gas is sufficiently low to extract water from the compound; and (10) the ninth aspect or any of its first to ninth variations wherein the hydrate/anhydrate compound includes a material that undergoes a reversable solid-to-solid phase change during dehydration and hydration and provides for additional energy storage and release in the form of physical material change in addition to providing for energy storage in the form of chemical bonds.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one of the above objects alone or in combination, or alternatively may address some other object of the invention ascertained from the teachings herein. It is not intended that any specific aspect or embodiment of the invention necessarily address any of the objects set forth above let alone address all these objects simultaneously, but some aspects and embodiments may address more than one of these objects.

### BRIEF DESCRIPTION OF THE DRAWINGS

FIG. 1 provides a schematic representation of an example energy storage and release system and method of an example embodiment of the invention using ibuprofen sodium dihydrate as an energy storage medium.

FIGS. 2A-2E provide powder x-ray diffraction patterns of ISD and ISA forms of ibuprofen sodium (FIG. 2A), TGA profiles of fresh ibuprofen sodium as a dihydrate, after dehydration, and after rehydration (FIG. 2B), DSC profiles of fresh ibuprofen sodium as a dihydrate, after dehydration and after rehydration (FIG. 2C), absorbance spectra with loss of water of crystallization during dehydration (FIG. 2D), and absorbance spectra with the gain of water during rehydration (FIG. 2E).

FIG. 3A provides a block diagram illustrating steps of a first process embodiment of the invention as well as some alternatives for some of the process steps wherein dehydration of storage medium occur by addition of energy (e.g. in the form of heat).

FIG. 3B provides a block diagram illustrating steps of a first process embodiment of the invention as well as some alternatives for some of the process steps wherein the dehydration of the storage medium is not limited to addition of heat energy.

FIG. 4 provides a block diagram illustrating various compound classes and specific example compounds in those classes that may be used in different embodiments of the invention.

FIG. 5 provides a block diagram of a thermochemical energy storage system of some embodiments of the invention.

FIG. 6 provides a block diagram illustrating various step in an embodiment of the invention that uses a combination of thermochemical energy storage and latent energy storage associated with a melting of an anhydrate form of a storage compound.

FIG. 7A-FIG. 7B provide a schematic representation of a screening process used in focusing research on to selected organic salt hydrates along with illustration of three specific hydrates with from three different classes.

FIG. 8A-8F provide various plots concerning performance of ISC as a thermochemical energy storage (TCES) material that includes some overlap with the performance plots of FIGS. 2A-2E.

FIG. 9 provides a table of dehydration temperatures reported for ibuprofen sodium dihydrate (ISD), the measurement conditions, the instrument used, and the source of the reporting.

FIG. 10 provides a table showing comparisons of thermochemical properties of selected salts.

FIG. 11 provide optical microscopy images of SCH show agglomeration and loss in structural stability due to incongruent melting during the cycling process from fresh strontium chloride hexahydrate (SCH) to 10^{th}, 20^{th}, and 30^{th} cycles.

FIG. 12A-12F provides various representations and plots concerning the in-situ molecular and structural characterization of ISD during dehydration and rehydration.

FIG. 13 provides XRD stack plots of calcium oxalate monohydrate (COM) depicting the formation of breakdown product (CaCO3) from the 10^{th} cycle.

FIG. 14 Comparison of loss in cycling efficiency of COM at two different temperatures (325° C. and 200° C.) during dehydration cycling (upper plot) and hydration cycling (lower plot).

FIGS. 15A and 15B provide in-situ FTIR full spectra plots showing that the majority of the changes during dehydration (FIG. 15A) and hydration (FIG. 15B) occurs mostly across the OH stretching band (the shaded region toward the left of the plots ˜3600 to 3200 cm⁻¹) and carboxylate stretching band (the shaded region toward right of the plots ˜1600 to 1400 cm⁻¹).

FIG. 16 provides XRD patterns of fresh ISD (hydrate), ISA upon the dehydration of ISA, and ISD upon rehydration of the ISA wherein dehydration of ISD at temperatures below the melting temperature of the ISA induces a solid-to-solid phase change that is completely recovered upon rehydration, as evident by the reflections corresponding to the hydrated triclinic phase of ISD.

FIG. 17 provides cell lattice parameters of fresh and ISD-150 samples (i.e., samples cycled 150 times) depicting minor changes in lattice parameters and cell volume due to cycling.

FIGS. 18A and 18B provide in-situ PXRD measurements showing a gradual transformation ISD to ISA monitored by the change in the reflections in a narrow 2θ region (at ˜3.5° 2θ corresponding to the triclinic phase of ISD) during dehydration (FIG. 18A) and the return of this peak to its original position during rehydration (FIG. 18B).

FIG. 19 provides a calorimeter dehydration profile showing complete dehydration (energy storage) by ˜64° C. when heated at a rate of 0.1° C./min.

FIG. 20A-FIG. 20D provide various plots showing cycling performance and stability of ISD under high-humidity conditions.

FIG. 21 provides a plot of weight change measurements when exposed to 90% relative humidity over 24 hours revealing a 69% increase, significantly exceeding the theoretical 13.62% weight gain expected for the incorporation of two water molecules.

FIGS. 22A-22C provide optical microscope images of a fresh ISD sample (FIG. 22A) before RH exposure, after exposing the sample to 90% RH for 3 hours (FIG. 22B) and after continued exposure to 90% for a total of 24 hours (FIG. 22C) wherein the images do not show deliquescence behavior at high RH conditions despite absorbing almost 5 times higher amounts of water compared to the theoretical weight gain from 2 moles of water.

FIG. 23 provides a table showing dehydration temperature, dehydration enthalpy, and melting enthalpy of fresh ISD and after 25, 50, 75, 100, 125, and 150 dehydration and hydration cycles measured from TGA/DSC.

FIG. 24 provides a comparison of FTIR spectra of fresh ISD and ISDafter 25, 50, 75, 100, 125, and 150 dehydration and hydration cycles showing no changes in the chemical structure or functional groups of ISD.

FIG. 25A-FIG. 25B provide comparisons of fresh, 5^{th}, and 150^{th} cycle hydrated samples (FIG. 25A) and anhydrous phase samples (FIG. 25B) with the inset depicting a loss of preferred orientation and thus a solid-to-solid phase change accompanying the dehydration-hydration cycling.

FIG. 26A-FIG. 26C provide solid state ¹H (FIG. 26A), ¹³C (FIG. 26B), and ²³Na (FIG. 26C) NMR spectrum of fresh ISD and ISA, and after 1st and 150 cycles wherein the NMR spectra depict consistent spectral features indicating molecular and structural stability upon cycling.

FIG. 27 provides a table comparing isotropic chemical shifts, quadrupolar coupling constants, asymmetry parameter, and peak widths of fresh (pristine) and anhydrous ibuprofen sodium samples.

FIG. 28A-FIG. 28E provide various plots of hydration kinetics and images of microstructural evolution of ISD during cycling.

FIG. 29 provides. Response time (RT) and discharge time (DT) of fresh and ISA-150 samples upon exposure to various relative humidity conditions measured by in-situ calorimetry.

FIG. 30 provides a table of hydration enthalpy released at different relative humidity conditions (90, 70, 50, and 40% RH) for fresh and ISA-150 samples showing consistent energy release indicating that ISA can be cycled at various RH conditions wherein the slight decrease in energy release at lower % RH is because of incomplete hydration due to constrained geometry of the sample inside the calorimeter.

FIG. 31 provides a table of weight gain data for both fresh and ISA-150 samples indicating that the ISA-150 achieved full hydration within one hour, whereas the fresh sample showed full hydration at higher 50-90% RH, but required more than one hour to fully hydrate at 40% RH. The faster and full hydration of ISA-150 sample is attributed to increased surface area and faster diffusion of water molecules due to pore formation and volume expansion.

FIG. 32A provides a schematic representation of TGA plots of a fresh sample and a self-discharge sample after 15 days under 10% RH at 25° C. while FIG. 32B provides schematic representations of DSC plots of the materials like those of FIG. 32A with each set of plots showing essentially no differences, indicating the ability of ISD to store and release energy without any losses during long-duration energy storage.

FIG. 33 provides a table of morphological parameters of crystals depicting changes in the area and max/min diameter and ferret diameter during hydration-dehydration cycling with schematic representations of the measurement orientation shown above respective columns.

FIG. 34A provides TGA profiles (left) and DSC profiles (right) of cromolyn sodium hydrate (CSH) while FIG. 34B provides similar profiles for nedocromil sodium hydrate with both showing full reversibility and stability across 5 cycles.

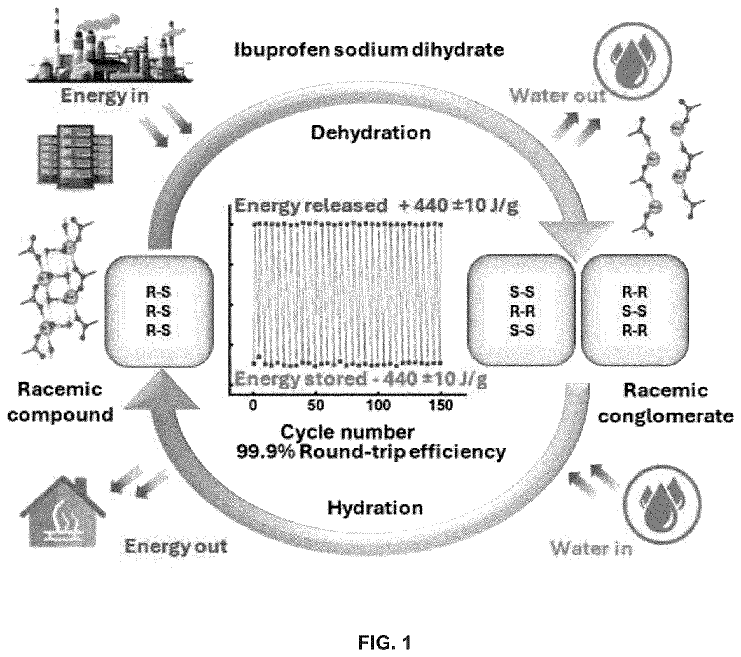

### DETAILED DESCRIPTION OF THE INVENTION

Various advantages and novel features of the present invention are described herein and will become even more apparent to those skilled in this art from the following detailed description. In the preceding and following descriptions a preferred embodiment of the invention is set forth by way of illustration of the best mode contemplated for carrying out the invention. As will be apparent to those of skill in the art after reviewing the disclosure set forth herein, embodiments of the invention are capable of modification in various respects without departing from the spirit of invention. Accordingly, the drawings and description of the embodiments set forth hereafter are to be regarded as illustrative in nature, and not as restrictive.

### Definitions

As used herein the following acronyms, terms, or phrases have the following meanings unless a different meaning is clear from the context in which the term or phrase is used.

A hydrate/anhydrate compound means a crystalline or molecular compound capable of transitioning between a stoichiometric or non-stoichiometric water containing state (hydrate or hydrous state), to a less water containing state (lower or less hydrate or hydrous state, a more anhydrate or anhydrous state), and potentially even to a waterless state (anhydrate or anhydrous state).

TCES means thermochemical energy storage where energy storage primarily exists within the chemical bonds of the molecular or crystalline structure of a storage material or compound

LHS means latent heat storage and is the energy absorbed or released during a phase change of a storage material or compound. The phase change may be associated with temperature and pressure such as a phase change between liquid and solid. Alternatively, the phase change may not be associated directly with temperature or pressure but may be associated with hydration and dehydration of a storage medium which can be retained so long as moisture retention or absence is maintained. Such hydration and dehydration based phase changes may provide for a solid-to-solid transition and provide reversible and additional energy storage and release.

IS means ibuprofen sodium as either ISD or ISA

ISD means ibuprofen sodium dihydrate or sodium 2-(4-isobutylphenyl) propanoate. ISD is classified as an ion associated hydrate as well as a channel associated hydrate.

Alendronate sodium trihydrate (AST) means 4-Amino-1-hydroxybutane-1,1-diphosphonic acid sodium in its hydrated form but it may also refer to the material as it transitions between its hydrated and dehydrated forms. AST is classified as an isolated site hydrate.

CSH refers to cromolyn sodium hydrate.

NSH refers to nedocromil sodium hydrate.

OSH refers to organic salt hydrates.

ISA means anhydrous ibuprofen sodium salt or ibuprofen sodium anhydrate (i.e., ISD with the water removed).

SCH refers to strontium chloride hexahydrate (SCH; SrCl₂·6H₂O).

COM refers to calcium oxalate monohydrate (COM; CaC₂O₄·H₂O).

Hydrate material names used herein generally refer to a hydrated form of a compound but may also refer to a compound's respective anhydrous form as it transitions between anhydrous and hydrated forms.

A hydrophobic backbone, as used herein, when referring to hydrates and anhydrates generally refers to a compound having a structure primarily composed of non-polar carbon-carbon or carbon-hydrogen bonds with some secondary polar bonds that can form hydrophilic channels or be present as specific sites (i.e., isolated sites or ion-associated sites) for storing and releasing water molecules.

### TES Material Examples

Some embodiments of the present invention are focused on the use of pharmaceutical/organic salt hydrates for TCES applications. Organic hydrates such as 2-(p-isobutylphenyl) propionic acid, known as ibuprofen) are proposed herein for use in thermal energy storage and moisture-involved electricity generation. Water molecules in organic salt hydrates can be reversibly & thermally cycled using a de/re-hydration process. As discussed above, pharmaceutical hydrates (including organic salt hydrates) with well-defined crystalline structures can be employed as TCES materials. In testing this hypothesis, two different pharmaceutical hydrates were initially selected and tested and then an additional two hydrates were selected and tested as discussed further hereafter. These initial two structures were selected based on the differences in the polar functional groups present in these drug compounds including carboxylate (ibuprofen sodium dihydrate (Sodium 2-(4-isobutylphenyl) propanoate)) and phosphonate (alendronate sodium trihydrate (4-Amino-1-hydroxybutane-1,1-diphosphonic acid sodium salt)) with sodium metal as a counter ion. Both these molecules have different crystal structure arrangements, and the water molecules are bonded differently with the parent compound. While ibuprofen is a representative material belonging to the class of ion hydrates where the water molecules are associated with the sodium ions, it can also be classified as a channel hydrate where the structure forms hydrophilic channels that allow the movement of water molecules. On the other hand, alendronate with a layered structure represents the class of isolated site hydrates where the water molecule is hydrogen bonded to the phosphonate or hydroxyl groups present in alternating layers of aminobutylene groups. These two molecules are representative of a broader class of pharmaceutical hydrates that could potentially be used for thermal energy storage.

### Ibuprofen Sodium Dihydrate:

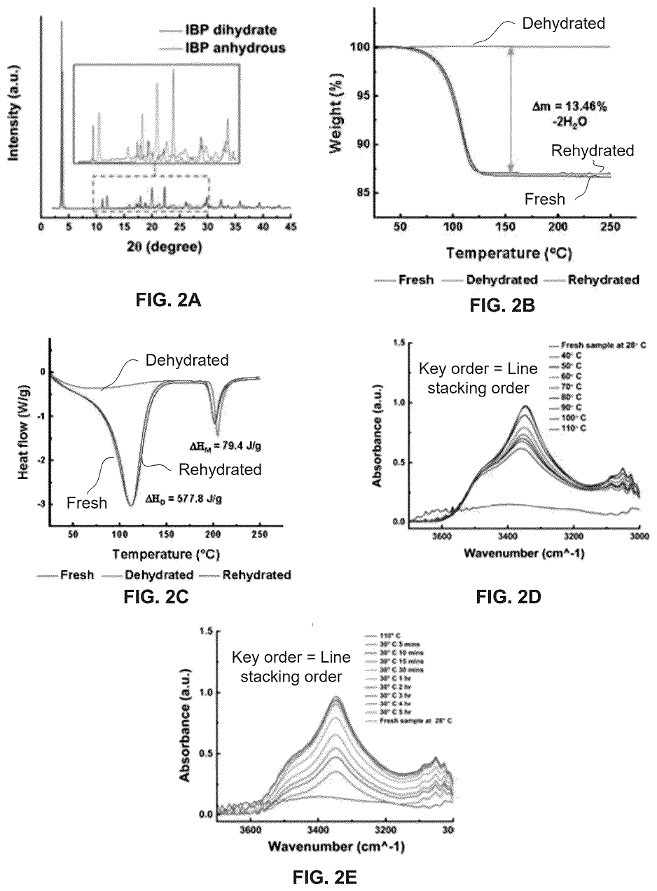

Here we demonstrate the potential of ibuprofen sodium dihydrate (racemic mixture) as a TCES material. In some alternative embodiments the ibuprofen sodium dihydrate may be a pure enantiomer or a non-racemic mixture of multiple enantiomers. Ibuprofen sodium dihydrate crystallizes in triclinic structure and loses two water molecules upon dehydration resulting in a distorted structure which is different from the hydrated compound. FIG. 2A shows the powder X-ray diffraction data (PXRD) of hydrated (ISD—black) and anhydrous (ISA—red) forms of ibuprofen. The PXRD pattern clearly shows that the ISD lattice contracts upon dehydration which is reflected by the shift in the peaks towards higher 2Θ values. It is also noted that the peak width of the ISA is wider as compared to ISD that are reflective of the distorted lattice structure. Thermal dehydration profile of ibuprofen was studied by Thermogravimetric Analysis (TGA) coupled with differential scanning calorimetry (DSC). As shown in FIG. 2B, fresh ISD shows a broad dehydration profile associated with loss of two water molecules at 113° C. In embodiments where heating rate is different, the dehydration temperature may vary. The ˜13.5% weight loss matches well with the theoretical weight loss associated with the loss of two water molecules from ISD (13.62%) suggesting that a complete dehydration of ISD can occur by 100° C. In embodiments involving different dehydration parameters, the complete dehydration may occur at different temperatures. Increasing the temperature further does not result in any additional weight loss up to a temperature of 250° C. indicating the thermal stability of ISD/ISA up to this temperature. A corresponding DSC profile of ISD/ISA is also shown in FIG. 2C which depicts two endothermic peaks with the first centered at around 113° C. (associated with the dehydration of ISD) and the second at around 201° C. (associated with the melting point of ibuprofen). The total enthalpy of dehydration is approximately 150 KJ/mol which can be regarded as the energy stored in the compound during its dehydration. A large separation between the dehydration and the melting point is ideally suited for thermal energy storage application as the dehydration process will not interfere with the melting of the sample. In addition, high thermal stability of ISA along with a sharp endothermic melting point is also good from application point of view making it useful as a TCES material as well as a phase change material or latent heat storage (LHS) material for thermal energy storage thereby increasing the overall energy that can be stored in this material. FIG. 2B and FIG. 2C also show via redlines the TGA and DSC profile of an ISA sample that was dehydrated at 100° C. for 5 hours and then run through an increasing series of temperatures to determine if any additional loss of mass occurred. As expected, ISA shows an absence of weight loss, when held in an anhydrous state, and heated from 25-250° C. range and a lack of an endothermic peak (60-100° C.) of dehydration is also evident. The ISA sample was rehydrated at a controlled rate at 25° C. and 40% relative humidity condition for 1 hour in preparation for further testing. The TGA and DSC profile of the rehydrated sample in FIG. 2B and FIG. 2C are shown via the blue lines are substantially identical to those of the fresh ibuprofen sodium dihydrate (ISD) confirming that ISA can be completely rehydrated and can function as an ideal TCES material.

To further understand the potential of ISD as a TCES, the in-situ dehydration and hydration mechanism was tested using Fourier Transform Infrared (FTIR) Spectroscopy. FTIR spectra of ISD shows a strong broad peak associated with two water molecules at 3345 cm-1 with a shoulder at 3475 cm-1 present in the OH region 3600-3200 cm⁻¹. In situ FTIR shown in FIG. 2D shows that the dehydration begins at greater than 40° C. as depicted by decrease in the intensity of the peak at 3345 cm⁻¹. Dehydration proceeds slowly with increase in temperature and about 50% of the water molecules are lost from the ISD as the temperature increases to 100° C. However, a drastic dehydration is observed at 110° C. suggesting that the water molecules retention in the compound are unstable beyond 100° C. and are drastically eliminated from the ISD/ISA lattice. In contrast the in-situ rehydration as seen in FIG. 2E follows a steady hydration within the experimental design. The OH peak lost during rehydration appeared within 5 minutes of cooling the sample at 30° C. and continued to increase steadily for 2 h. However, it took about 5 h for the OH peak to restore to the similar intensity as seen with the fresh hydrated ISD sample which can be ascribed to the testing conditions. The exact replication of the FTIR spectra post hydration of the dehydrated ibuprofen suggest that the water molecules were fully incorporated within the ibuprofen lattice and the bonding environment was also fully restored.

It is important for a TCES material to be stable under multiple thermal dehydration and hydration cycles. Since ISD undergoes a phase transition during its transformation between the hydrated (ISD) and dehydrated (ISA) isomorphs, it is important to investigate its ability to absorb and release water during multiple hydration and dehydration cycles. The stability of ibuprofen during multiple hydration and dehydration cycles was tested. The ISD/ISA was cycled for 150 complete dehydration and hydration cycles. The stability was monitored by measuring the weight loss during dehydration and weight gain during the hydration process. The resulting data suggested that hydration and dehydration of the ISD/ISA is highly reversible with negligible changes to its ability to absorb or lose water molecules making it an ideal TCES material.

The FTIR data together with the thermal cycling data clearly suggest that ISD/ISA is an ideal candidate for application as TCES material. Even though the loss of water of crystallization from the ISD lattice results in slight distortion of the ISA crystal structure, the change in the volume and overall crystal disordering is well accommodated over repeated hydration and dehydration cycles.

Embodiments of this invention relate to new materials for thermal energy storage applications. They specifically relate to the use of organic salt hydrates as materials for thermochemical energy storage through a process of dehydration (energy storage) and hydration (energy release). At present, the field of TCES materials is dominated by the research on inorganic salt hydrates with organic salt hydrates having not been explored for TCES application.

Sources of energy play a big role in determining the fate of global carbon emissions. Achieving an aggressive target of net zero emission by 2035 will require drastic changes in energy generation and storage technologies as well as improving overall efficiency. While renewable energy sources present a best-case scenario for generating clean energy, their intermittent nature coupled with fluctuating energy demand needs their pairing with energy storage technologies. Thermal energy storage has appeared as an alternative technology to serve the domestic and industrial space including water heating applications that can take the load off the electric grid and improve the overall efficiency of the systems. Specifically, the materials discovered and set forth in this patent application can be used for designing thermal energy storage systems serving the domestic space and water heating needs. The materials described can potentially offer advantages over the materials currently in use. Potential problems addressed by some embodiments, general attributes of inorganic salt hydrates, and general attributes of certain organic salt hydrates are set forth in the following table:

| | Inorganic salt hydrates | Organic salt hydrates |
|---|---|---|
| Problem | tend to | tend to |
| Deliquescence | Be highly deliquescent and | Be hydrates with hydrophobic |
| | need special additives for | organic backbones and |
| | preventing deliquescence or | hydrophilic channels that do |
| | nucleating agents | not show deliquescence |
| Pulverization | Have large volume changes in | Be less susceptible to changes |
| | the crystal structure leading to | in the crystal volume and |
| | pulverization | pulverization |
| Corrosive | Be highly corrosive requiring | Be generally non-corrosive |
| | special materials for handling, | |
| | storage, and application | |
| Cost | Vary in cost depending upon | Have cost that can be reduced |
| | the type of salt | by bulk scale synthesis of |
| | | organic compounds |
| Number of material combinations | Have a limited number of salts | Have unlimited combinations |
| | that can be combined. | possibilities through synthetic |
| | | organic chemistry |

The organic salt hydrates/anhydrates of the various embodiments of the present invention, and particularly those with hydrophobic organic backbones along with hydrophilic sites or channels, may address these problems individually or in various combinations.

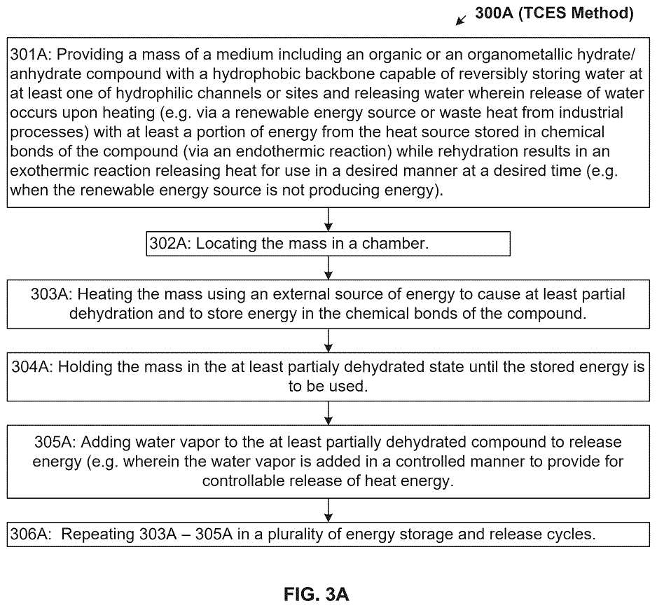

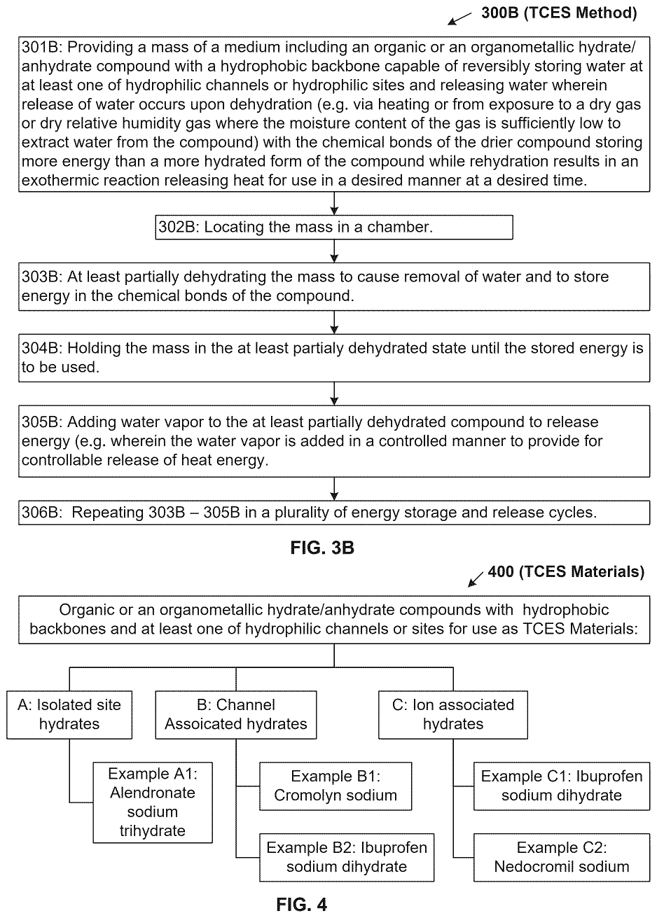

FIG. 3A provides a block diagram 300A illustrating steps of a first process embodiment of the invention as well as some alternatives for some of the process steps. Step 301A calls for the providing of a mass of a medium including an organic or an organometallic hydrate/anhydrate compound with a hydrophobic backbone along with hydrophilic sites or channels capable of reversibly storing water in the hydrophilic channels or sites and releasing water wherein release of water occurs upon heating (e.g. via a renewable energy source or waste heat from industrial processes) with at least a portion of energy from the heat stored in chemical bonds of the compound (via an endothermic reaction) while rehydration results in an exothermic reaction releasing heat for use in a desired manner at a desired time (e.g. when the renewable energy sources are not producing energy). Step 302A calls for locating the mass of the compound in a chamber which provides for holding the mass within control parameters that will be used in controlling humidity, atmosphere, pressure, temperature, as week as inward and outward heat flow. The chamber may be insulated vessel or reactor. The chamber may be manmade or a natural cavity with a size appropriate for a desired quantity of energy storage compound that will used. Step 303A calls for heating the mass (e.g., assuming it was at least partially hydrated) using an external source of energy to cause at least partial dehydration of the storage compound as it absorbs and holds energy from the heat input within the chemical bonds of the compound. Step 304A calls for holding the mass in the at least partially dehydrated state, so as to retain the energy therein in the chemical bonds of the compound. Its temperature may be held at a temperature that was attained during the at least partial dehydration. The temperature may be allowed to transition to a higher temperature possibly capped at something below the melting temperature of the compound to avoid any negative phase change issues or it may be allowed to move to a temperature at or above a phase change temperature to allow capture of additional energy. In other variations, the temperature after dehydration may be allowed to drop where the heat energy output that is eventually useable would be primarily sourced from the exothermic reaction of hydration. Step 305A calls for adding water vapor to the at least partially dehydrated compound to provide rehydration and energy release. The water vapor may be supplied in the form of a flow of humidified gas (e.g., air or nitrogen). The water vapor may be supplied in a controlled manner to provide for controlled energy release. Step 306A calls for repeating steps 303A to 305A in a cyclic manner to provide energy storage when excess energy is available and release of energy when it is needed. In some variations the storage medium may undergo a solid-to-solid phase change as water is removed and added such that additional energy is stored in the dehydrated compound due to latent energy associated with a molecular or physical reorganization that occurs in association with the dehydration which is reversed with energy being released upon rehydration.

FIG. 3B sets forth a process 300B that is a variation of process 300A of FIG. 3A wherein the heat and energy and associated heat source or energy source of FIG. 3A is replaced with a more general dehydration step and an associated dehydration source as noted in Steps 301B and 303B. Steps 302B, 304B, 305B, and 306B are similar, mutatis mutandis, to the corresponding steps of FIG. 3A. In some variations the dehydration source may be same as that of FIG. 3A. In other variations, it may be a source of dry gas or dry relative humidity gas which may be provided, for example, as flow of such gas with the gas being completely devoid of water or having a moisture content that is sufficiently low to provide for removal of water from the compound down to a desired dehydration level and energy storage level. In still other variations, the dehydration source may be a hybrid source providing, for example, a combination of a dry gas (e.g. a relatively dry gas) and heat which may be applied in parallel or in series to provide for a desired dehydration level.

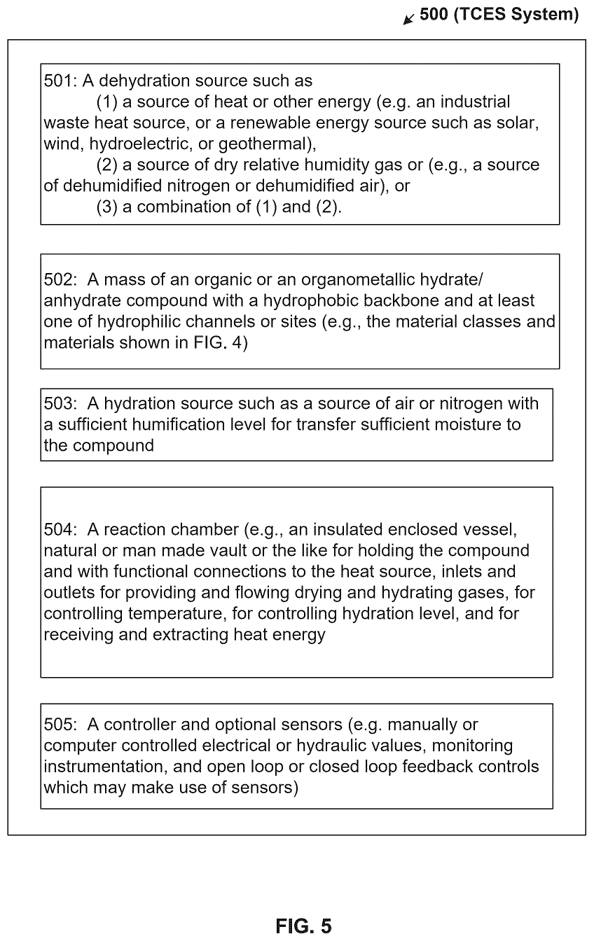

FIG. 4 provides a block diagram 400 illustrating various compound classes and specific example compounds in those classes that may be used in different embodiments of the invention. In particular, block diagram 400 shows the existence of three hydrates classes A-C with at least one example of a functional thermochemical medium or compound associated with each class.

FIG. 5 provides a block diagram 500 of a thermochemical energy storage system of some embodiments of the invention with various elements (501-505) of the system identified and examples provided.

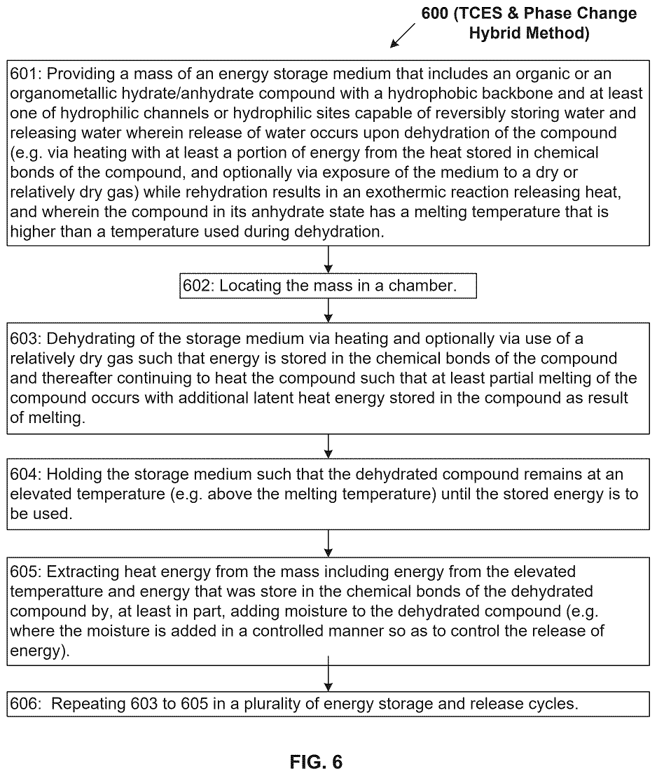

FIG. 6 provides a block diagram 600 illustrating various steps (601 to 606) in an embodiment of the invention that uses a combination of thermochemical energy storage and latent energy storage associated with a melting of a storage medium that includes an anhydrate form of energy storage compound so that additional energy may be stored and accessed for a given volume or mass of the storage medium.

In some embodiment variations, a single storage medium compound may be used while in others, the storage medium may use two or more compounds so long as each of the multiple compounds can effectively operate under the dehydration and hydration conditions that are used. For example, if heating is used for dehydration each material should be able to operate under the applied temperature conditions while retaining energy storage and release reversibility.

### Additional Examples, Experiments, and Analysis

In addressing the shortcoming noted above in the background section, and as briefly noted above, attention was turned, to organic salt hydrates (OSH), a largely underexplored class of materials with advantages such as structural stability, tunable properties and highly scalable synthesis processes. Their hydrocarbon backbone can be tuned via chain length, sterics, and complexity, offering flexibility in structure to better accommodate volume changes, hydrophobicity to prevent deliquescence, and functionality for attracting and storing water. Owing to their diversity and tunability, the melting point and dehydration temperatures of OSH can be optimized to recover available waste heat from a diverse range of temperatures, especially low temperature waste heat for applications in residential and industrial heating and cooling systems.

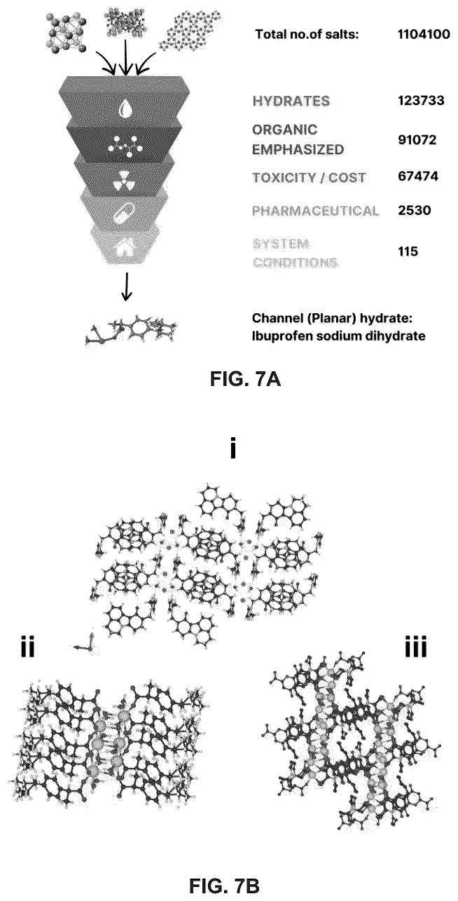

In investigating OSH materials, a database of crystalline compounds was screened using PDF-5+ software, which included data from the International Centre for Diffraction Data (ICDD), Cambridge Crystallographic Data Centre (CSD), Fachinformationszentrum Karlsruhe (ICSD), Materials Phases Data System (LPF), and National Institute of Standards and Technology (NIST), collectively cataloging ˜1.1 million salts. By applying a series of filters, a listing of reported structures for hydrates (123,733 salts) was obtained. After which inorganic salts were excluded to emphasize OSH materials, reducing the pool to 91,072 salts. Further filtering removed highly toxic (e.g., Hg, Pb, Tl) and expensive elements associated with OSH materials (e.g., noble metals such as Pd, Pt, Au, Ag) and reduced the pool to 67,474 OSH materials. Among these, further narrowing focused down to pharmaceutical hydrates due to their well-defined crystal structures that have been studied extensively and offer predictable hydration-dehydration behaviors which leaving only 2530 potential candidates. This systematic screening process is illustrated in the schematic representation of FIG. 7A.

As noted above, pharmaceutical hydrates can be categorized into three types based on their crystal structures. These three classes of crystalline pharmaceutical hydrates are illustrated in FIG. 7B by providing an example of each: (i) isolated site hydrates as illustrated by Cilansetron hydroxychloride monohydrate, (ii) channel hydrates as illustrated by Ibuprofen sodium dihydrate, and (iii) ion-associated hydrates as illustrated by Nedocromil sodium trihydrate. Among these, channel hydrates offer easier and often fully reversible hydration and dehydration pathways with better structural stability, while ion-associated hydrates show higher energy storage capacity owing to the association of water molecules with ions. Further filtering was applied to restrict elements to only C, O, H, and Na for reducing the selection to channel and ion-associated hydrates, and low molecular weight: <300 g/mol for achieving better energy density. This greatly reduced our selection to 115 pharmaceutical OSH materials. A manual evaluation of the remaining compounds was carried out, targeting low temperature waste heat recovery applications (50-120° C.), suitable for residential or commercial hot water applications, or recovering heat from data centers. Additional considerations included the selection of widely used technologically mature pharmaceutical compounds, high raw material market availability, bulk-scale manufacturing, and a well-defined hydrate structure. Ibuprofen sodium dihydrate (C₁₃H₁₇NaO₂·2H₂O) (ISD) was selected as a representative compound for evaluating its potential as a proof-of-concept OSH in TCES applications. ISD is a widely used nonsteroidal anti-inflammatory drug with a well-defined hydrate structure, well-characterized reversible dehydration, scalable synthesis and a mature manufacturing and distribution network, making it an ideal candidate for TCES exploration. ISD's performance and properties were compared against two promising salt hydrates: strontium chloride hexahydrate (SCH; SrCl₂·6H₂O) and calcium oxalate monohydrate (COM; CaC₂O₄·H₂O), providing valuable context for assessing ISD's performance as a TCES material.

To evaluate the potential of ISD as a TCES candidate, its hydration-dehydration dynamics were examined which are critical for efficiency, reversibility, and long-term stability assessment. Thermogravimetric analysis (TGA) and differential scanning calorimetry (DSC) were employed to analyze ISD's thermal behavior in both the dehydrated and anhydrous states. In-situ humidity-controlled calorimetry was used to analyze the heat gain and loss during dehydration and hydration.

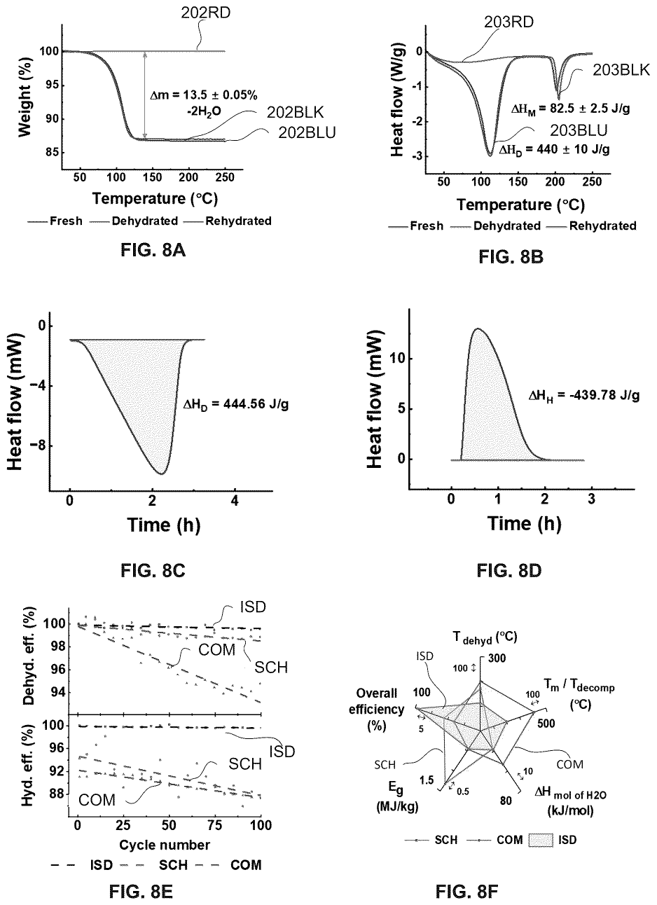

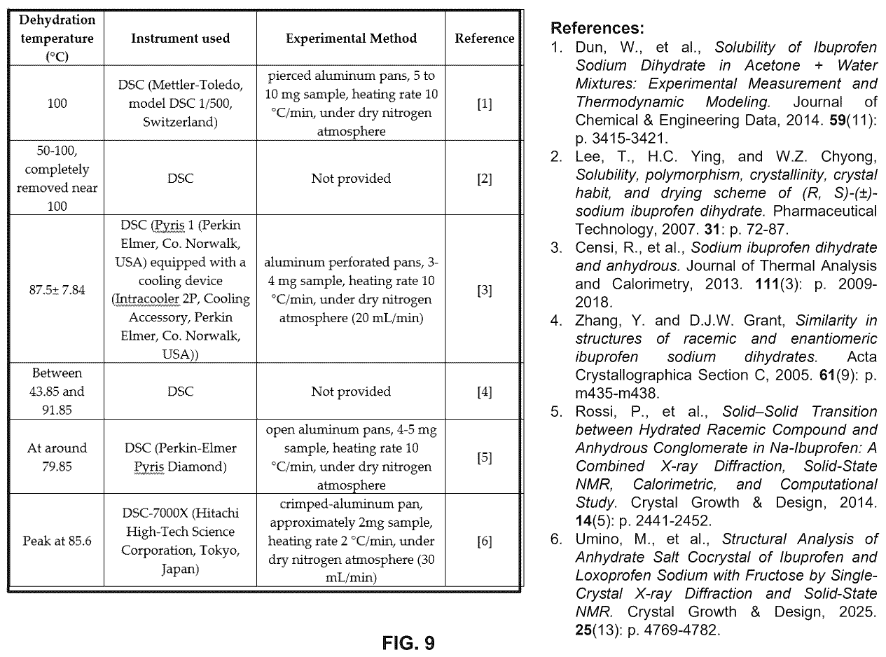

FIG. 8A-8F provide various plots concerning performance of ISC as a thermochemical energy storage (TCES) material that includes some overlap with the performance plots of FIGS. 2A-2E. FIG. 8A provides thermogravimetric (TGA) profiles of fresh ISD (black) 202BLK, ISA (red) 202RD, and rehydrated sample (blue) 202BLU exhibiting full mass reversibility. FIG. 8B provides differential scanning calorimetry (DSC) analysis profiles of fresh ISD (black) 203BLK, ISA (red) 203RD, and rehydrated sample (blue) 203BLU indicating consistent dehydration and melting enthalpies upon cycling. FIG. 8C provides a humidity-controlled calorimetric measurement plot depicting a dehydration energy value in agreement with the DSC results. FIG. 8D (provides an in situ calorimetric measurement plot demonstrating full energy release during hydration of ISA. FIG. 8E provides dehydration and hydration cycling efficiency plots of ISD, SCH, and COM over 100 cycles. FIG. 8F provides a spider plot comparing ISD, SCH, and COM based on key TCES energy storage properties. The values for gravimetric energy density (E_{g}), melting/decomposition temperature (Tₘ/T_{decomp}), and dehydration enthalpy per mol of water (ΔH_{mol of H2O}) were measured for ISD and compared with literature-reported values for SCH and COM. The 100^{th} cycle overall efficiency was measured experimentally and calculated as an average of dehydration (experimental mass loss/theoretical mass loss*100) and hydration (experimental mass gain/theoretical mass gain*100) efficiencies for all three salts. The TGA profile of fresh as received ISD as shown in FIG. 8A (which is similar to FIG. 2B) revealed 13.5±0.05% mass loss, accounting for the release of two water molecules, aligning well with the theoretical mass loss of 13.6% and previous reports. ISD has its peak dehydration temperature at 113° C. (10° C./minute heating rate), compared to the peak dehydration temperature of SCH at 170° C. and COM at 200° C. The dehydration temperature of ISD is consistent with previous studies, which report varying temperatures based on the measurement conditions as shown in the table of FIG. 9). This low dehydration temperature range makes it ideal for harnessing energy from low-grade heat sources, such as waste heat from industries and data centers.

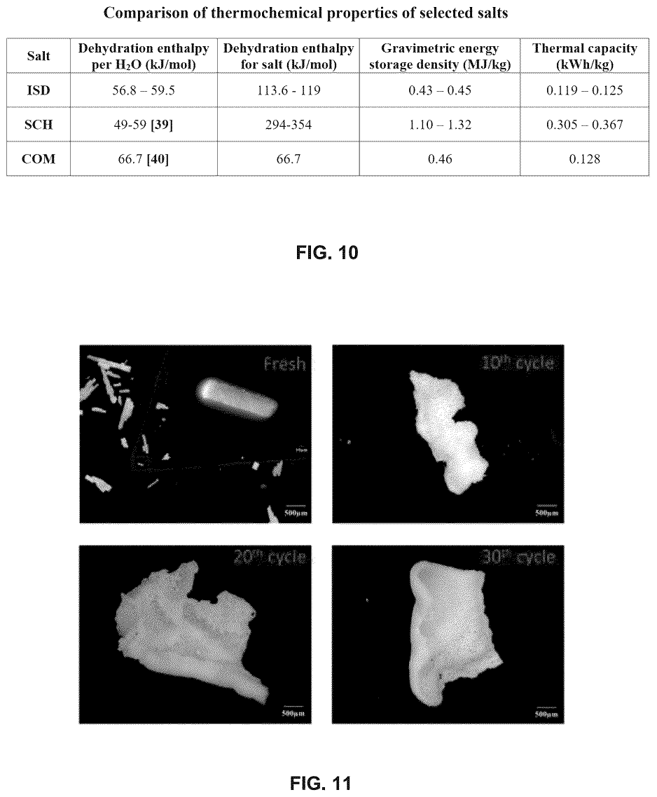

The DSC profile of a fresh ISD sample as shown in (FIG. 8B) indicates two significant thermal events. Firstly, the dehydration peak is observed at 113° C. (at 10° C./minute heating rate), with an enthalpy change of 440±10 J/g (113.6-119 kJ/mol). This value is higher than the previously reported literature values (198±15 J/g and 400 J/g) however, the experiments yielding FIG. 8B were performed with a larger sample mass (15 mg as compared to 3-4 mg in previous reports) and with a closed lid configuration of the sample cell, which allows for homogenous heat distribution in the DSC sample pan. The dehydration enthalpy was 389-405 J/g in an open lid configuration, which is still higher than the values reported by Censi et al (Censi, R., et al., Sodium ibuprofen dihydrate and anhydrous. Journal of Thermal Analysis and calorimetry, 2013. 111(3): p. 2009-2018) but closer to the values from Rossi et al) Rossi, P., et al., Solid-Solid Transition between Hydrated Racemic Compound and Anhydrous Conglomerate in Na-Ibuprofen: A Combined X-ray Diffraction, Solid-State NMR, calorimetric, and Computational Study. Crystal Growth & Design, 2014. 14(5): p. 2441-2452). During dehydration, ISD is dehydrated to ibuprofen sodium anhydrous (ISA; C₁₃H₁₇NaO₂) due to the loss of two water molecules. A comparison of the dehydration enthalpy of different salts shows a remarkable dehydration enthalpy of ISD (56.8-59.5 kJ/mol) per mole of water as shown in the table of FIG. 10), which is comparable to both SCH and COM. The dehydration enthalpy per unit mole of salt is much higher for SCH (able to store 6 water molecules) compared to ISD and COM.

The second thermal event occurs at slightly higher temperatures and depicts a sharp melting peak of ISA at 201.6° C., with a melting enthalpy of 82.5±2.5 J/g. This peak indicates the transition of solid ISA to the molten state, typical of phase change materials (PCMs) that store and release thermal energy through melting and crystallization. The TGA profile of ISA shows the absence of a dehydration peak and reveals only one thermal event corresponding to the melting of ISA. The absence of any other endothermic peak at lower (120°, 189° C.) or higher temperature (>230° C.) range corresponds to the absence of α and β polymorphs and the S enantiomer, respectively. The slight increase in the melting enthalpy of ISA could be ascribed to the melting of a solid ISA monolith as compared to its powder form in ISD (resulting from the initial melting of ISD during the first TGA run). The fusion enthalpy of ISD can be utilized to store waste heat available at higher temperatures. A substantial temperature gap of 88.6° C. between the dehydration and melting temperature is advantageous for maintaining system stability and preventing premature transitions from the thermochemical to phase change mode caused by unexpected temperature fluctuations. COM exhibits a similar wide separation between its dehydration (223.8° C.) and decomposition (410° C.) temperatures while dehydrated SCH does not decompose up to its melting point (>1000° C.).

While DSC shows the ability of ISD to store energy, the hydration energetics of ISA were evaluated using in-situ calorimetric measurements. The humidity-controlled in-situ calorimetric measurement is pivotal in analyzing the heat stored and released during the dehydration and hydration measurements, respectively. One of the major advantages of the in-situ calorimetric setup is that it allows testing of higher amounts of sample (100 mg in current experiments), giving a better representation of average sample behavior compared to 5-10 mg of sample that is typical for most studies reporting the hydration/dehydration values from TGA-DSC measurements. The exposure of samples to flowing humid gas (40% RH, 75 mL/min, 25-120° C. at 0.1° C./min during dehydration and 90% RH, 75 mL/min during hydration at RT) mimics the real application environment of TCES materials. Calorimetric measurements of ISD demonstrated a dehydration energy storage value of 444.6 J/g (117.5 kJ/mol) as shown in FIG. 8C, which agrees well with the TGA-DSC value of 440±10 J/g. This also suggests that the discrepancy in the dehydration enthalpy of ISD from TGA-DSC measurements in the reported literature (see FIG. 9) must also be assessed by calorimetric measurements. The hydration enthalpy (or the heat release) of ibuprofen under flowing humid nitrogen gas was found to be 439.8 J/g (116.3 kJ/mol) as shown in FIG. 8D and demonstrates the stability and reproducibility of both dehydration and hydration of ibuprofen sodium salt.

The hydration and dehydration cycles of the three salts (ISD, COM, and SCH) were optimized to ensure complete dehydration and hydration of each sample (2 g) within 1.5 h of exposure. The full dehydration of ISD, COM, and SCH was achieved at 125° C., 220° C., and 325° C., respectively. The weight change in each sample was recorded after every subsequent cycle, and the difference in mass was used to calculate efficiency during cycling. A decrease in the dehydrated salt mass indicates the possibility of salt decomposition, while a decrease in hydrated salt mass suggests an inability to hydrate fully over successive cycles. As depicted in FIG. 8E, ISD demonstrated the highest overall efficiency of 99.9% after 100 cycles (calculated as an average of dehydration and hydration efficiencies) as compared to SCH (93.4%) and COM (91.0%), showcasing ISD's long-term stability over conventional salts. While SCH shows a higher energy storage capacity compared to both ISD and COM, it depicts a complicated incongruent melting behavior accompanied by dehydration, melting at a much lower temperature (˜61° C.), and breaking down into SrCl₂·2H₂O with the release of 4 water molecules. The incongruent melting leads to agglomeration and monolith formation, necessitating the use of additives during its practical operation (FIG. 11). Similarly, while COM benefits from a wider temperature gap between its dehydration and decomposition temperatures, its stability is highly sensitive to dehydration conditions, such as heating rate and water vapor environment.

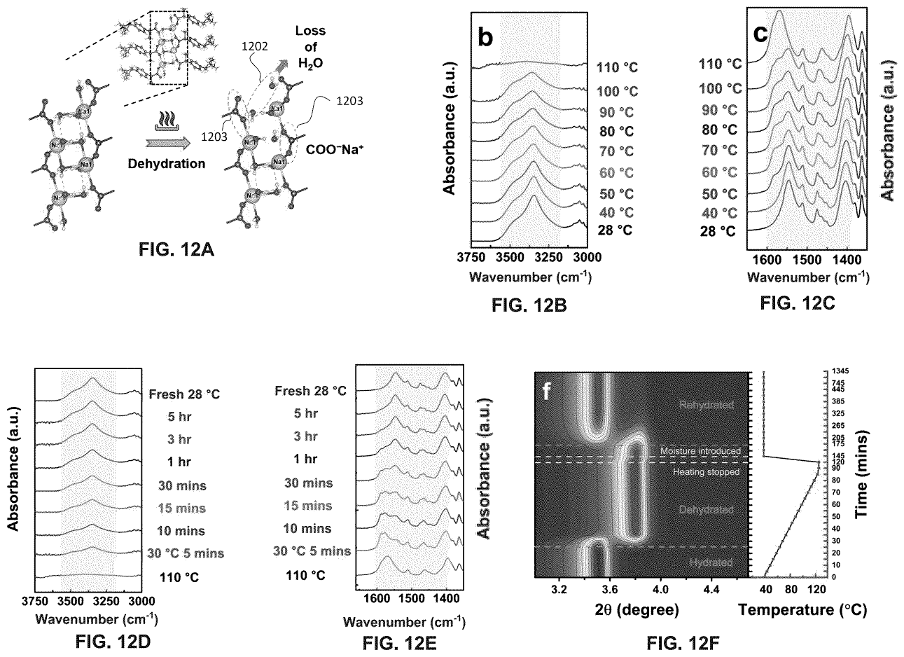

FIG. 12A-12F provides various representations and plots concerning the in-situ molecular and structural characterization of ISD during dehydration and rehydration. FIG. 12A provides a schematic representation of molecular changes in ISD accompanying the release of two water molecules exemplified by oval 1202 (red oval) and a change in carboxylate bonding environment exemplified by oval 1203 (blue oval). FIG. 12B provides in-situ FTIR spectra showing the progressive disappearance of the O—H stretching band (3600-3200 cm⁻¹) during dehydration, reflecting the removal of water molecules while FIG. 12C depicts the frequency separation between O—C—O at v_{asy}(˜1550 cm⁻¹) and v_{sy}(˜1404 cm⁻¹) increasing during dehydration indicating a shift in bonding environment. FIG. 12D depicts the reappearance of the O—H stretching band during rehydration as time progresses indicating water reabsorption into the crystal lattice. FIG. 12E depicts the COO⁻ stretching band returning to its original frequency as water molecules reintroduce a hydrated coordination environment. FIG. 12F shows and in-situ PXRD pattern during dehydration and hydration cycling of ISD showing the disappearance of a diffraction peak corresponding to the triclinic phase of ISD accompanied by the appearance of a new ISA peak at higher 2 theta values. Hydration restores the structure of ISD as observed by the appearance of a peak at 3.5°.

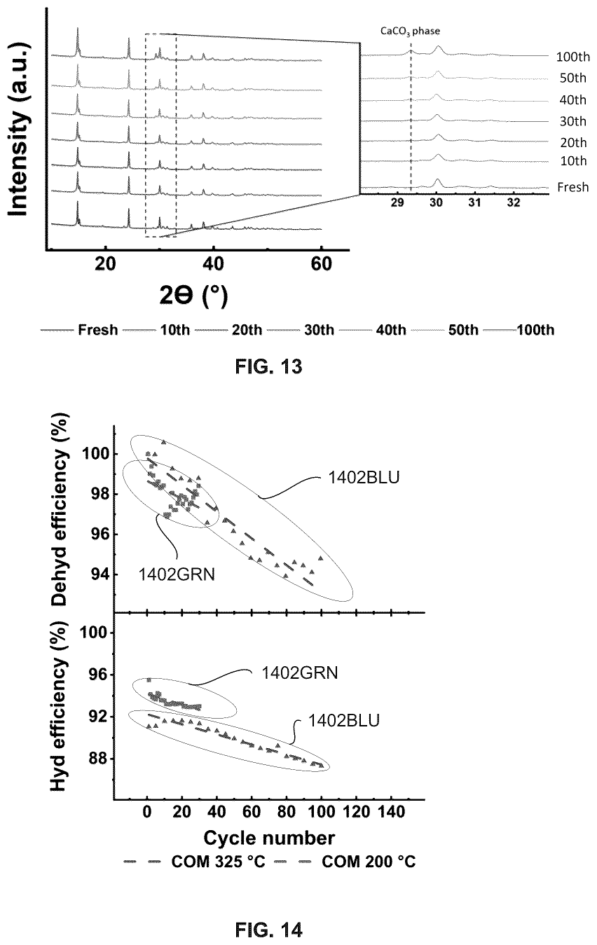

COM exhibited a decline in overall efficiency to 91% over 100 cycles under experimental conditions including dehydration at 325° C. for 1.5 hours in a muffle furnace followed by hydration at 25° C. and 90% RH for 1 hour. This suggests partial decomposition into CaCO₃ as illustrated in the plots of FIG. 13 from the 10^{th} cycle. Even under milder dehydration conditions of 200° C. for 1.5 h in a muffle furnace, a similar drop in efficiency was observed as can be seen in the hydration and dehydration plots of FIG. 14 with 200° C. plot shown in generally in the region of 1402GRN and the 300° C. plot shown in the region of 1402BLU, indicating that COM is prone to instability at temperatures well below its decomposition temperature of 410° C. The difference in the cycle stability observed in our experiments compared to that reported by Knoll et al (Knoll, C., et al., Probing cycle stability and reversibility in thermochemical energy storage —CaC2O4·H2O as perfect match? Applied Energy, 2017. 187: p. 1-9) can be ascribed to significant differences in the cycling test conditions. Overall, ISD's low dehydration temperature, high dehydration enthalpy per mole of water, and excellent cycling efficiency present compelling evidence for its application as a TCES material in recovering low-grade heat.

Understanding the molecular and structural changes occurring in ISD during hydration and dehydration is pivotal to understanding its performance as a TCES material. Ibuprofen exists in two enantiomeric forms, (R) and(S). Ibuprofen's sodium derivative, ISD, crystallizes as a dihydrate and offers improved solubility compared to ibuprofen. In terms of its enantiomeric occurrence, ISD is proposed to occur as a true racemic compound (true racemate), a homogenous solid containing an equimolar ratio of two enantiomers. Its anhydrous counterpart, ISA, can occur as a pure racemic compound in one of two possible metastable polymorphs (α and β) or as a racemic conglomerate, a physical mixture of two enantiomers which are present as two separate solid phases (γ-form). The γ-form of ISA contains only one type of enantiomer in its unit crystal lattice, while in a racemic compound, both enantiomers co-exist within the same crystal lattice. The crystal structures for racemic (R, S) and enantiomeric (S) ISD have been solved; however, the structure of anhydrous ISA is not yet resolved. The structure of the racemic compound of ISD contains two specific hydrophilic and hydrophobic regions. The hydrophilic region is characterized by the presence of sodium ions that link ibuprofen molecules in a one-dimensional infinite chain bridging through the carboxylate groups. These chains are further linked by water molecules by bonding the bridging sodium ions to form a one-dimensional zipper-like arrangement, zipping the R and S units on each side of the sodium ions. This forms the hydrophilic channel for water molecules to move in and out of the structure, making the water removal from ISD akin to a channel hydrate. The tight bridging of both water molecules with two sodium ions and their hydrogen bonding with oxygen atoms from the carboxylate anions ensures that both water molecules are lost at the same temperature from the lattice as observed by a single peak in the TGA-DSC profiles in FIG. 8A and FIG. 8B. The loss of two water molecules during the dehydration of ISD follows a structural rearrangement of carboxylate anions around the sodium ions and the isobutyl fragments that occur repeatedly across dehydration and hydration cycling of ISD, as depicted by the schematic in FIG. 12A. These molecular and structural transitions were studied by in-situ Fourier-transform infrared (FTIR) spectroscopy and in-situ powder X-ray diffraction (PXRD).

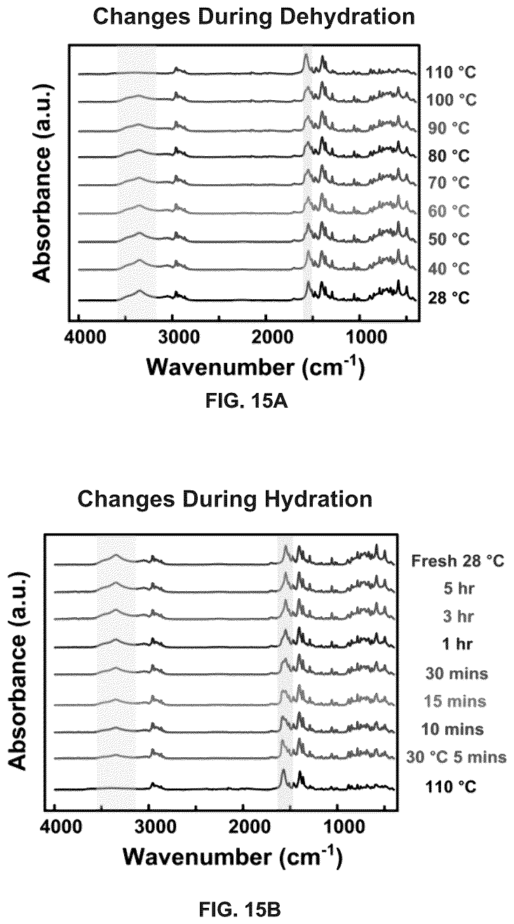

The in-situ FTIR spectra provided insights into the dynamics of molecular rearrangements of the water molecules and the carboxylate groups that are directly affected by the removal of water molecules. The room temperature FTIR spectra (FIG. 15A and FIG. 15B) of the fresh ISD sample show a rich feature spectrum from the vibrations of various structural and functional groups in ISD. The peak positions and intensities agree well with the previously reported room temperature IR spectra of ISD. An in-situ FTIR spectrum was collected by increasing the temperature of the attenuated total reflectance (ATR) accessory from room temperature to 110° C. in steps of 10° C. for studying the changes during dehydration of the ISD. Major spectral changes during dehydration (FIG. 12B and FIG. 12C) and hydration (FIG. 12D and FIG. 12E) were observed in peaks corresponding to the O—H stretching region (3600-3200 cm⁻¹) and O—C—O stretching region (˜1400-1600 cm⁻¹) (FIGS. 15A and 15B). The O—H stretching band, shown in FIG. 12B, depicts notable changes with increasing temperature. The O—H stretching band continues to broaden with increasing temperature, consistent with increasing vibrational degrees of freedom. The peak intensity gradually decreases with time due to the loss of water molecules and completely disappears at 110° C., indicating a complete removal of water from the crystal lattice. This observation matches the TGA/DSC data and is consistent with the observation of Bogatinovska et al (Cvetkovska Bogatinovska, E., et al., Infrared and Raman spectra of racemic ibuprofen sodium dihydrate—Spectra-structure correlations. Spectrochimica Acta Part A: Molecular and Biomolecular Spectroscopy, 2025. 339: p. 126190), who also reported the complete disappearance of peaks associated with the OH stretching peak from a sample dehydrated at 110° C. The carboxylate groups directly bonded to the sodium ions are also bonded to water molecules through hydrogen bonding and are highly sensitive to the degree of hydration. The room temperature v_{asy} (O—C—O) stretching peak in ISD appears at 1550 cm⁻¹ while the symmetric stretch v_{sym} (O—C—O) appears at ˜1404 cm⁻¹, which is consistent with previous reports (FIG. 12C). The energy separation (Δ_{Va-s}˜141 cm⁻¹) between the asymmetric and symmetric vibrations (Δ_{Va-s}) points to a bidentate type of configuration of carboxylate ions of hydrated ISD. During dehydration, the asymmetric stretching peak shifts from 1545 cm⁻¹ in fresh ISD to 1570 cm⁻¹ in ISA, reflecting enhanced electrostatic interactions between sodium ions and carboxylate groups as water molecules are lost from its coordination environment. On the contrary, the symmetric stretching peak shifts from 1404 cm⁻¹ to 1395 cm⁻¹, respectively. The increased separation (Δ_{Va-s}˜175 cm⁻¹) points to a change in the bonding environment from bidentate towards a more ionic (or monodentate) type configuration or significant changes to the bond angle and bond lengths that agree with the reorganization of the structure during ISD-ISA transformation (vide infra). Interestingly, a small shoulder observed at ˜1576 cm⁻¹ in fresh ISD, previously ascribed to the HOH bending mode, showed an increase in intensity with a shift towards higher frequencies. While Bogatinovska ascribed this peak to the HOH bending mode, our observations of in-situ dehydration suggest that this peak assignment should be reassessed, as evident by its increasing intensity with temperature and appearance in the spectra of dehydrated ISA.

Rehydration of ISA under ambient laboratory conditions restored all the peaks of ISD. The reappearance of the O—H stretching band and shifting of v_{asy} (O—C—O) and v_{sym} (O—C—O) peaks to their original hydrated position indicate that reintroduction of water into the lattice follows complete recovery of molecular structure (FIG. 12D and FIG. 12E). It must be noted that the rehydration process required up to five hours under ambient conditions (RH˜30%) due to the sample's densely packed nature, limiting moisture diffusion. The most striking feature is the appearance of a prominent IR peak at 1586 cm⁻¹ during rehydration, which finally becomes a weak shoulder after complete hydration of ISA to ISD. The appearance of this peak during the dehydration and rehydration process points to the possibility of a metastable monohydrate form with a prominent peak for the H—O—H bending mode. Even though the dehydration of ISD appears to occur in a single step, the possibility of a stepwise water addition could explain the appearance of a prominent H—O—H bending peak. The structural complexity of ISD and ISA, which shows a high degree of disorder, makes it difficult to interpret the appearance and movement of these peaks during cyclic hydration and dehydration conditions. These observations agree with previous reports indicating massive structural reorganization of an already disordered crystal. These structural transformations were further studied by in-situ PXRD measurements.

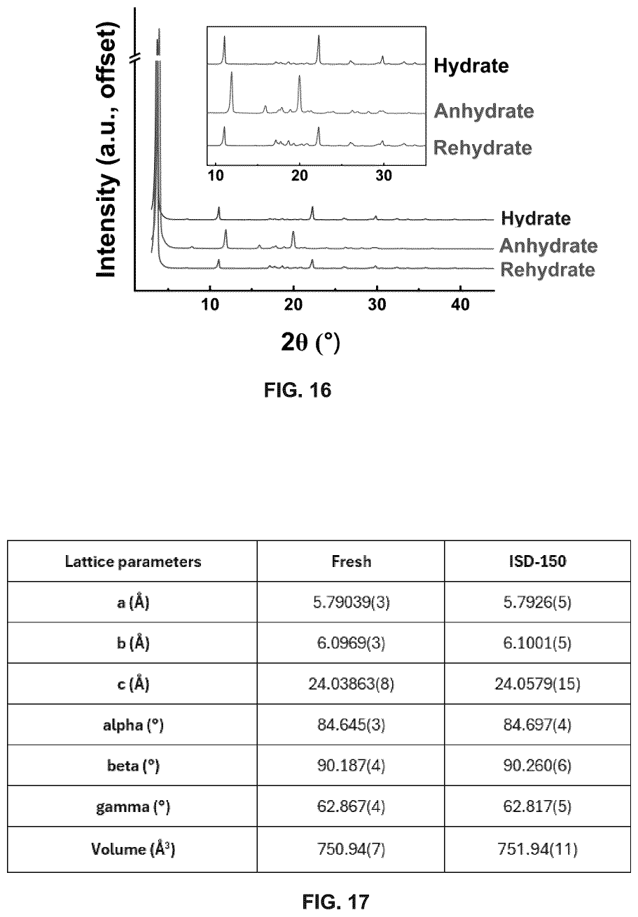

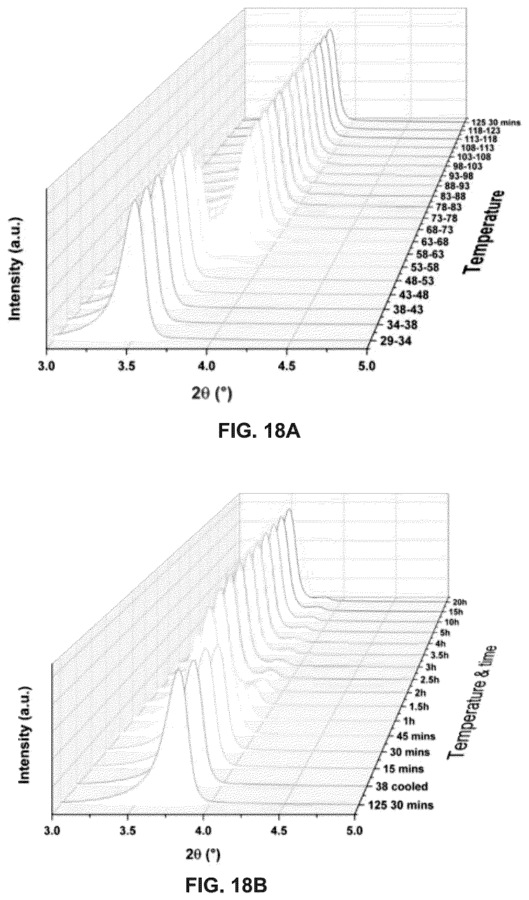

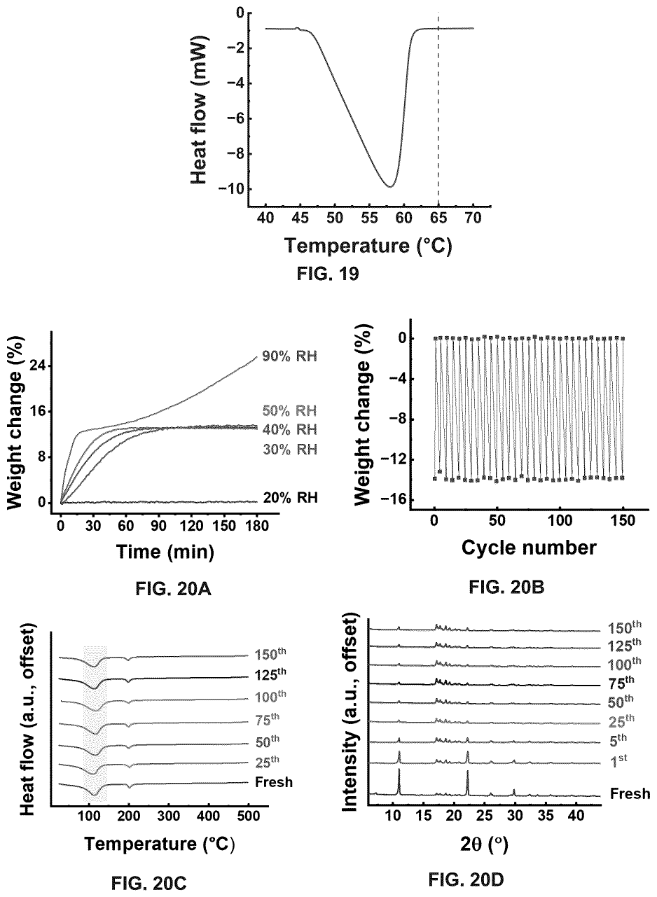

(RS) ISD crystallizes as a triclinic structure in the P1̅ space group. The structure is highly disordered due to the disordered nature of the isobutyl fragment of ibuprofen. The PXRD patterns of fresh and anhydrous ISD are shown in FIG. 16. The diffraction pattern of fresh ISD suffers from preferred orientation, consistent with previous observations, which eventually reduces upon repeated cycling (vide infra). PXRD patterns of both ISD and ISA and the derived lattice parameters of ISD (FIG. 17) match well with the previous reports. The broad nature of the diffraction peak in ISA confirms that the disorder is significantly higher in ISA as compared to the disorder in ISD. The structural changes during dehydration were monitored by in-situ PXRD by heating the samples from room temperature (RT) to 125° C. at 1° C./minute and holding them at this temperature for 30 minutes. The structural transition between the anhydrous and hydrated form is depicted using the most intense diffraction peak (˜3.5° 2θ) in FIG. 12F. During dehydration, this peak at 3.5° disappears while a new peak at 3.8° appears, characteristic of the phase transition of ISD to ISA. Similar to the DSC and FTIR observations, the PXRD measurements (FIG. 12F, FIG. 18A, and FIG. 18B) show gradual dehydration with peaks corresponding to anhydrous ISA appearing at 53-58° C. The majority of the phase transition from ISD to ISA occurred at 63-68° C., while the complete disappearance of peaks corresponding to ISD occurred at 103-108° C. The dehydration temperature of in-situ XRD is lower because of the slower heating rate. calorimetric measurement of ISD at slower heating rates of 0.1° C. per minute also shows complete dehydration at ˜64° C. (FIG. 19). In-situ rehydration of the sample by injection of humid gas (40% RH, 150 mL/min) in the PXRD chamber restored the original triclinic phase of ISD as confirmed by the gradual appearance of peak (˜3.5°) corresponding to ISD. The rehydration was slow, and residual peaks associated with the anhydrous phase persisted for a couple of hours post-hydration due to sample packing density and the test geometry of in-situ XRD that restricted the permeation of humidity inside the sample compartment. Ex-situ PXRD measurements (FIG. 16) under optimal hydration conditions validated that ISD achieves complete rehydration and structural recovery. ISD is postulated to undergo a dramatic structural change during its transition from a racemic compound in ISD to a racemic conglomerate in ISA. As described earlier, the sodium cations bridge two ibuprofen carboxylate molecules, forming an infinite 1-D chain as depicted in FIG. 12A. In racemic ISD, each of these 1D chains is composed of only R or only S enantiomers, and they are bridged by the water molecules (bonding to carboxylate oxygen and sodium atoms), forming the hydrophilic channels. The bridging by water molecules also gives ISD its racemic compound configuration by combining both R and S configurations within a unit cell. Removal of the water molecules leads to the separation of independent R and S chains, which are projected to reorganize and pair separately, reorganizing as a racemic conglomerate giving rise to the γ phase of ISA as confirmed by the appearance of new peaks in PXRD. This drastic reorganization was supported by the fact that the dehydration enthalpy of (RS) ISD is about 50% higher than the dehydration enthalpy of its pure enantiomer(S) ISD. Excess enthalpy is required for the complex solid-state reorganization that accompanies its dehydration. The absence of any other endothermic peaks during dehydration (FIG. 8B) (or after repeated dehydration) confirms that both dehydration and re-organization of the structure occur concurrently. The absence of other endothermic peaks between dehydration and melting point indicates the absence of a to β transformation or its melting, confirming that ISD only transforms into its γ form of racemic conglomerate (as suggested by its melting at ˜201° C.). The complex coupling of the dehydration and phase transformation suggests that the thermal energy storage mechanism of ISD combines both physical (phase change) and chemical (dehydration) forms of energy storage. This unique energy storage mechanism differentiates ISD from other inorganic salt hydrates, opening a pathway for designing a new class of compounds that can demonstrate a combined phase transformation with reversible chemical reaction for thermal energy storage and release.

These findings depict ISD's ability to undergo a full hydration-dehydration-rehydration cycle without decomposition, phase separation, or loss of crystallinity. However, it is important to test the reversibility of the extensive reorganization of R and S enantiomers during phase transformation between ISD and ISA. We further tested the structural and chemical stability of ISD under repeated hydration and dehydration cycles, which are vital for TCES applications designed for long-term cycling. A kinetic rate experiment was conducted to determine the optimal humidity conditions for cycling ibuprofen with the results shown in FIG. 20A.

FIG. 20A-FIG. 20D provide various plots showing cycling performance and stability of ISD under high-humidity conditions. FIG. 20A provides a plot of kinetic rate measurements depicting the % weight gain and changes in the hydration rate as a function of relative humidity. FIG. 20B provides a plot of weight loss and gain of ISD during dehydration and hydration over 150 cycles with only every 5^{th} cycle being shown, depicting its remarkable stability and reversibility. FIG. 20C provides DSC profiles of ISD at selected intervals over 150 cycles, showing stable dehydration and melting temperatures and enthalpies. FIG. 20D shows PXRD patterns of fresh and selected cycled ISD samples (1^{st} and after every 25 cycles) demonstrate remarkable phase stability, with intensity reductions in selected peaks attributed to a loss of preferred orientation.

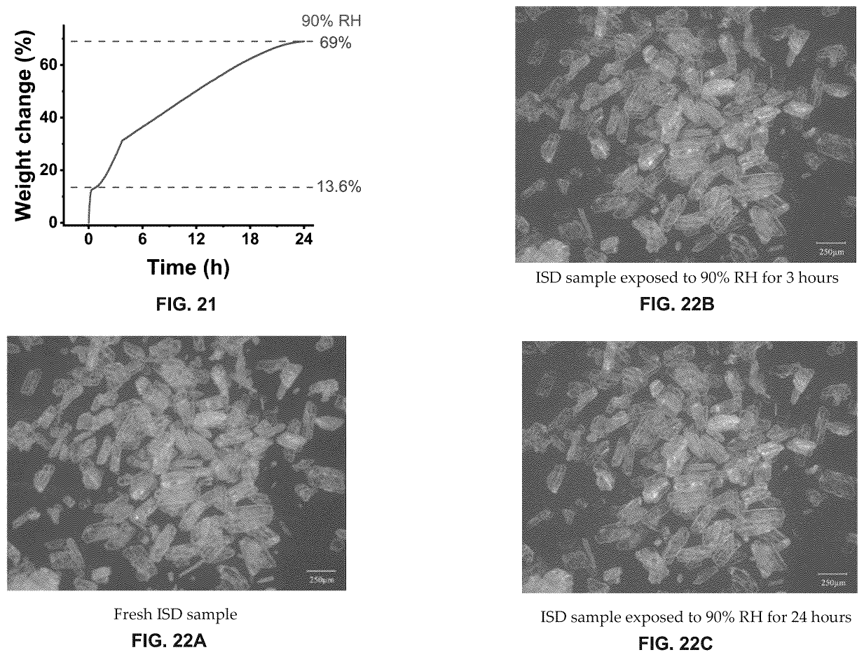

The rate of hydration increases with exposure to higher relative humidities at room temperature. Full hydration of ISA (˜14%) was achieved within 40 minutes at 90% RH, while at lower 30% RH full hydration took longer than 120 minutes. Although ISA demonstrated rehydration capability at even lower relative humidities (30-50% RH), a 90% RH setting for 1 h duration was selected for the hydration cycling resulting in a weight gain of 13.7-14% ensuring full hydration without absorbing excess moisture. It is worth noting that even though ISD is at higher RH, it did not show deliquescence behavior even after exposure to 90% RH for 3 h, despite a 69% weight gain as shown in FIG. 21. Optical images of samples before RH exposure (FIG. 22A), after exposure to 90% RH for 3 hours (FIG. 22B) and after exposure to RH for 24 h (FIG. 22C) show that the particle morphology did not change significantly, confirming that ISD does not show a deliquescent behavior. Testing the hydration of ISD at higher RH (90% RH) enabled evaluation of ISD rehydration under the RH conditions necessary for hydration of other salts, such as SCH (for comparison), and facilitating faster hydration (vide infra). Additionally, it allowed us to assess ISD's performance in high-humidity environments, ensuring its reliability and effectiveness in demanding applications. For dehydration experiments, it was found that heating the ISD at 110° C. for 1 h results in complete dehydration of the sample. To ensure complete dehydration under cycling conditions, 115° C. for 1.5 hours was selected for dehydration cycling. The ISD was exposed to 150 dehydration and hydration cycles at these fixed hydration and dehydration conditions to assess its cycling efficiency, molecular, and structural stability. Thermal cycling experiments revealed the remarkable stability of ISD after being cycled 150 times (ISD-150) (FIG. 20B). Both the dehydration and hydration cycling efficiencies of ISD remained consistent at ˜99.9% compared to COM and SCH, which showed a loss in the overall cycling efficiency (93.4% and 91%) within 100 cycles (see FIG. 8E). ISD's reversible dehydration (energy storage) and hydration (energy release) capacity over multiple cycles without any loss in mass changes underscores its robustness and thermal reliability as a TCES material.

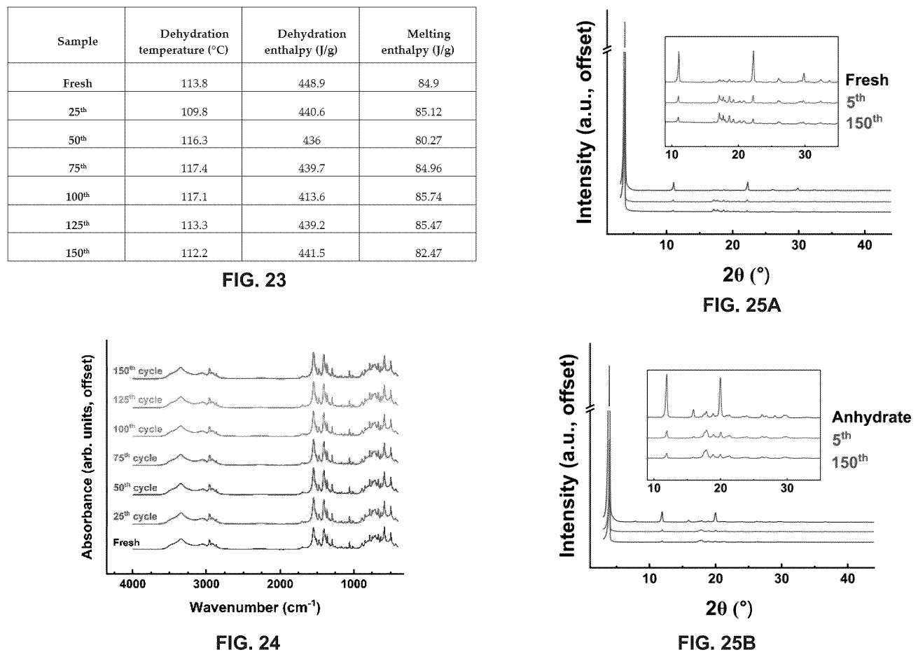

Thermal analysis of ISD using TGA-DSC demonstrated consistent dehydration and melting behaviors across all 150 cycles, as depicted in FIG. 20C. The dehydration enthalpy (energy stored) and dehydration temperature range depicted minimal changes as shown in the table of FIG. 23, reflecting ISD's ability to reliably store and release energy during cycling. The melting peak of ISA (at 10° C./min) shifted slightly from 201° C. to 199° C., with no changes in melting enthalpy. The lack of any new endothermic peaks in the DSC signal further confirms that hydration-dehydration cycles do not lead to the formation of the α or β phase of ISD and that its conformational purity (as a racemic conglomerate) is maintained. FTIR spectra of ISD depicted insignificant changes in the position of O—H and COO⁻ stretching regions with no new peaks, confirming that the material's chemical environment remained unchanged throughout cycling as can be seen in FIG. 24. PXRD patterns of FIG. 20D revealed no further peak shifts or new phase formation, indicating that ISD maintained its crystal structure. The fresh ISD PXRD plot of FIG. 20D shows high intensity peaks at 2θ values 3.6, 11.0, 22.2, and 29.8°. These high intensity peaks are ascribed to the preferred orientation in microcrystalline powder. Intensity reductions in these specific diffraction peaks during cycling are indicative of changes in the preferred orientation during hydration-dehydration cycling due to repeated structural transitions from ISD to ISA (FIGS. 25A-FIG. 25B). A comparison of the crystal lattice parameters of fresh and ISD-150 as set forth in the table of FIG. 17 depicts a minor increase in lattice parameters (˜0.16%) and cell volume (0.13%) after cycling, despite a potential massive realignment of the R—S domains between ISD and ISA during each successive cycling.

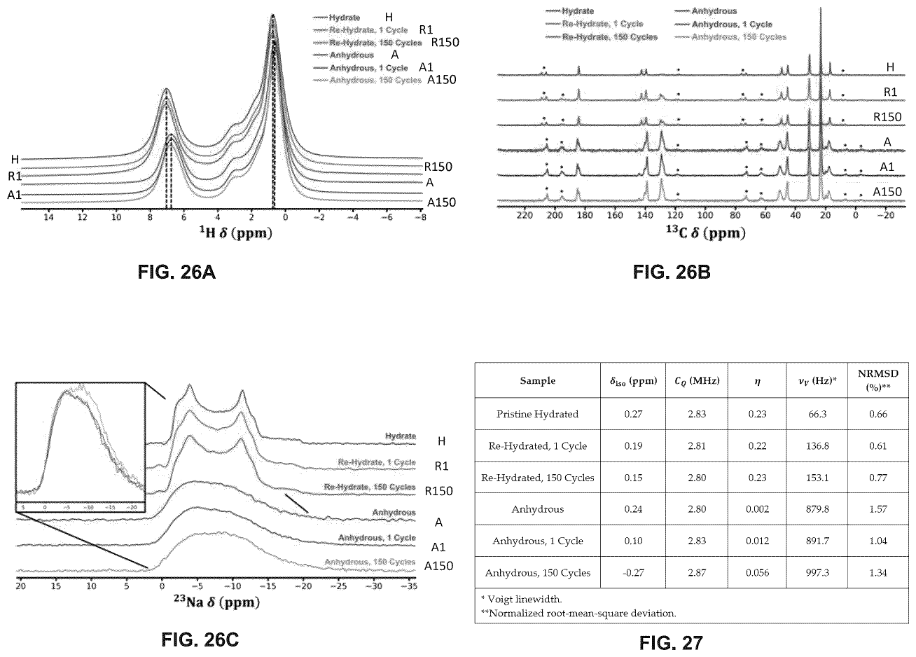

The effect of multiple cycles on the structural stability and reorganization was further studied by solid-state ²³Na, ¹H, and ¹³C magic-angle spinning (MAS) NMR spectroscopy (FIG. 26A-FIG. 26C). 1H MAS-NMR spectra of FIG. 26A show two resolved ¹H signals at ˜1 and 7 ppm ascribed to the aliphatic and aromatic protons of ibuprofen. The 7 ppm ¹H signal in ISD also contains a contribution from the water of crystallization, as observed by the slight shift in the ¹H peak of the ISA. The ¹³C MAS-NMR spectra of FIG. 26B show 9 peaks corresponding to inequivalent aliphatic and aromatic carbons in ibuprofen wherein the asterisks refer to the spinning sidebands. The spectral shifts in both ISD and ISA agree with previous results reported by Rossi et al. (Rossi, P., et al., Solid-Solid Transition between Hydrated Racemic Compound and Anhydrous Conglomerate in Na-Ibuprofen: A Combined X-ray Diffraction, Solid-State NMR, calorimetric, and Computational Study. Crystal Growth & Design, 2014. 14(5): p. 2441-2452.) and Carignani et al. (Carignani, E., S. Borsacchi, and M. Geppi, Dynamics by Solid-State NMR: Detailed Study of Ibuprofen Na Salt and Comparison with Ibuprofen. The Journal of Physical Chemistry A, 2011. 115(32): p. 8783-8790) including the splitting of peaks in the spectrum of ISA. The ¹³C peaks of ISA are significantly broader than those of ISD which provides a preliminary indication that the structural disorder is much higher in ISA. An even stronger indication of a high degree of structural disorder in ISA is evident in the ²³Na MAS-NMR spectra of FIG. 26C, as the quadrupolar line shape is affected greatly by the degree of its hydration state. Slight broadening of the ²³Na NMR peak of the ISA after 150 cycles refers to increasing disorder in the sample. The quadrupolar line shape of ISD consists of a well-resolved pattern with a moderate Co (2.8 MHz) and asymmetry parameter (˜0.2) as can be seen in the table of FIG. 27, with minimal intrinsic line broadening, which only minutely increases with increasing number of cycles. Upon dehydration, the line shape drastically transforms: while it still fits optimally to a comparable Co as that of ISD, the intrinsic line broadening has increased for all cycle numbers by a factor of >6, indicative of further increase in the degree of structural disorder in agreement with previously discussed XRD results, and consistent with the transformation of a racemic compound (ISD) to a racemic conglomerate (ISA) upon dehydration. Comparing the ²³Na, ¹H, and ¹³C NMR spectra of fresh and 150 cycles ISD and ISA nevertheless demonstrates an excellent reversibility indicative of chemical and structural stability, with slight increase in the structural disorder evident from the ²³Na NMR data.

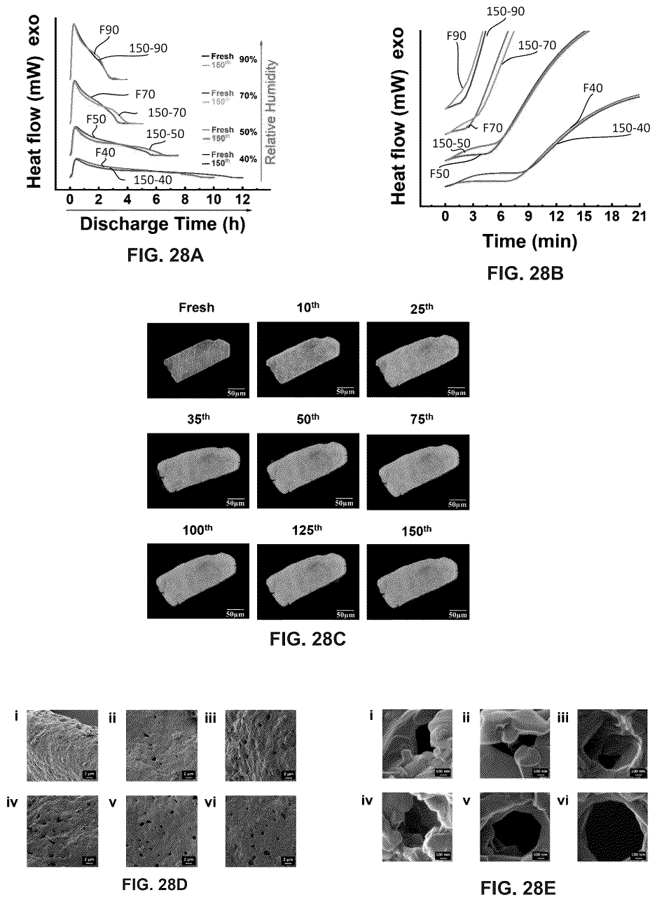

FIG. 28A-FIG. 28E provide various plots of hydration kinetics and images of microstructural evolution of ISD during cycling. FIG. 28A provides plots of hydration kinetics (response & discharge time) and stored energy release from fresh and 150th cycle ISA samples exposed to varying relative humidity conditions. FIG. 28B provides plots of early-stage hydration kinetics of the samples depicted in FIG. 28A using similar coloring. FIG. 28C provide optical microscopy images of ISD from selected cycles ranging from fresh uncycled to 150 thermal cycles, showing the initiation of surface defects such as pores and cracks, and achieving a stable morphology after 75 cycles. FIG. 28D images from helium ion microscopy (HIM) of ISD illustrating the progressive increase in the number of pores formed due to repeated hydration-dehydration cycles with number of cycles associated with each image being (i) 25, (ii) 50, (iii) 75, (iv) 100, (v) 125, and (vi) 150. FIG. 28E provides higher magnification HIM images highlighting the expansion and propagation of individual pores, revealing the deepening and widening of surface defects as cycling progresses with the number of cycles associated with each image being (i) 25, (ii) 50, (iii) 75, (iv) 100, (v) 125, and (vi) 150 cycles.

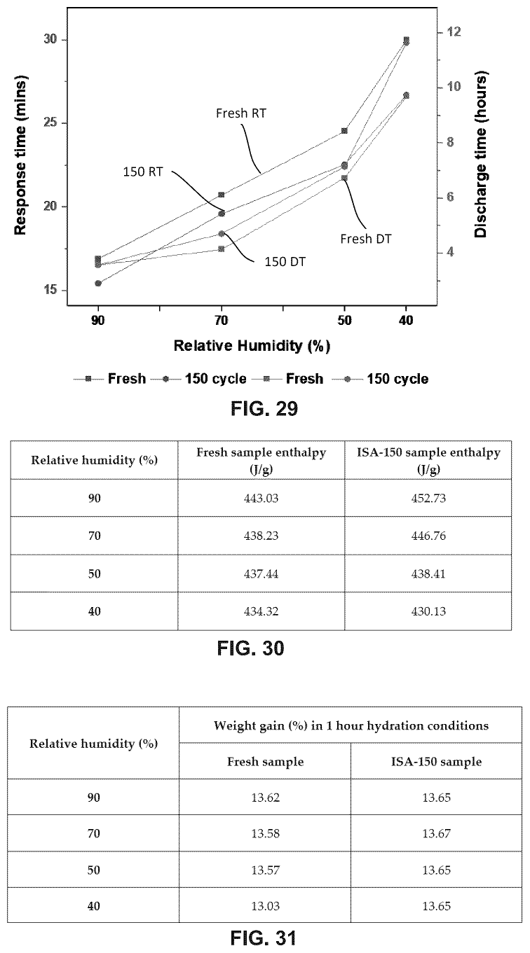

The effect of reversible structural realignment (true racemate, ISD to racemic conglomerate, ISA) on the responsiveness of ISA towards hydration was analyzed by in-situ calorimetric measurements. A comparison of the hydration response time (how fast the stored energy is released), total discharge time (how long it takes to release the stored energy), and total energy released (how much stored energy is released) upon hydration at different relative humidity levels for fresh ISA to 150 dehydration and hydration cycles is depicted in the plots of FIG. 28A, the plots of FIG. 29 and the table of FIG. 30. The response time was defined as the time taken to achieve a spike in heat release after exposure to the specified RH, while the discharge time was defined as the time taken for achieving full hydration, i.e., when the heat release reached a steady baseline value. The initial response time for the ISA cycled 150 times was faster compared to the fresh ISA at all RH conditions. For each humidity in FIGS. 28A, two plots are shown with the plots distinguished by color and labeling with fresh ISA plots shown with “F” followed by a number corresponding to the humidity percentage while the cycled ISA plots are labeled with “150-” followed by a number corresponding to the humidity percentage. FIG. 28B as similar labeling and coloring to that used in FIG. 28A and shows that at low relative humidities, below 70%, fresh ISA shows an initial gradual heat release which approaches a limiting hydration state, followed by a rapid release of thermal energy. This thermal energy release profile of fresh ISA suggests that initially, the sample is hydrated on the surface, and the rate of hydration is limited by the area of the sample exposed and the concentration of the available surface water molecules. Once a minimum level of surface hydration is achieved, the water molecules can easily diffuse inside the structure owing to its channel-like structural arrangement for accommodating water molecules, causing a rapid release of energy. Repeated cycling causes surface cracks and pores on the surface of ISA as can be seen in FIG. 28C and FIG. 28D, increasing its exposed surface area for interaction with water molecules at specific RH conditions. Thus, the response time of ISA cycled for 150 times (ISA-150) is faster than the response time for fresh ISA and shows slightly higher heat release in the initial limiting hydration state. This limiting hydration state is less pronounced at higher RH conditions >70% as both ISA and ISA-150 show nearly identical response times (FIG. 29). At higher humidities, the moisture concentration gradient is sufficiently high, increasing the rate of hydration and corresponding energy release. The full hydration of the ISA will depend upon the rate of diffusion of water molecules inside the ISA. Censi, et al (referenced above) indicated that the hydration of ISA follows a 2D diffusion model, following experiments conducted at different temperatures at 64% RH. Once a steady state diffusion is reached, further diffusion of water inside the ISA is affected by the concentration gradient, which acts as the driving force. This concentration gradient decreases over a period of time, with increasing hydration level of ISA, thus decreasing the amount of heat energy released over a period of time. The total thermal energy released at different RH conditions for both fresh and cycled ISA were nearly identical as shown in the table of FIG. 30, indicating that the structural and morphological changes do not affect the heat energy storage or release capacity of ISD over multiple cycles.

FIG. 28A also shows that the discharge time of ISA can be tuned by changing the relative humidity of the flowing gas with a larger spike release of thermal energy observed at higher relative humidities. However, a comparison of discharge times of fresh and 150^{th} cycle sample measured from the calorimeter depict a complicated behavior. At a high relative humidity of 90%, both fresh ISA and ISA after 150 cycles exhibited similar discharge times; however, at lower humidity levels (70%, 50%, and 40% RH), the discharge time was significantly higher for the ISA-150 as compared to the fresh sample. This slower discharge time, despite increased porosity and surface area, reflects limitations of the test geometry rather than a material limitation. In calorimetric experiments, 100 mg of the ISA sample is loaded in a stainless-steel cell inside the calorimeter, forming a cylindrical shape analogous to a sample inside a plug flow reactor. However, the humid nitrogen gas does not flow through the sample but instead enters and leaves the calorimeter from the top, exposing only the top side of the sample to a continuous flow of humid gas. The ISA sample on the bottom side is exposed to the humidity that has percolated through the sample. Thus, the duration of total hydration, which depends upon overall exposure of the sample to humidity, is influenced by the sample height (or length) inside the calorimeter and the RH of the flowing nitrogen.

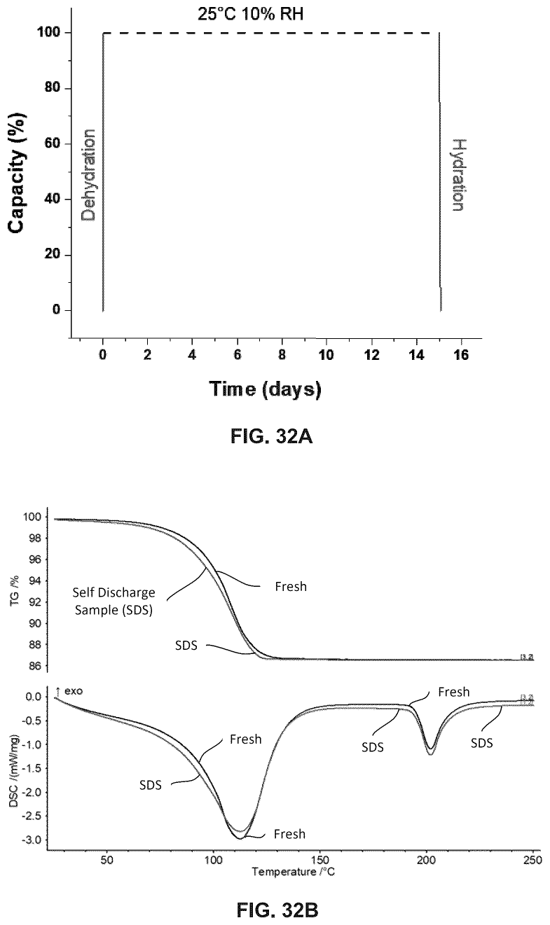

To further validate this observation, 100 mg of fresh and ISA-150 were spread evenly in a Petri dish and exposed to different relative humidities inside a humidity chamber. A full discharge of 100% hydration (13.6% weight gain) for both fresh and ISA-150 was achieved after 1 h exposure to different RH values (FIG. 31). This confirms that the dehydration and hydration cycling of ISA does not influence its hydration rate negatively, and the longer hydration observed from calorimetric experiments was due to the limitations of the test geometry. The self-discharge capacity of ISD was tested by storing ISA at 10% RH for 15 days and assessing the weight change upon hydration and the heat released upon dehydration. The results are depicted in FIG. 32A and FIG. 32B and indicate no self-discharge upon storage at 10% RH conditions for 15 days.

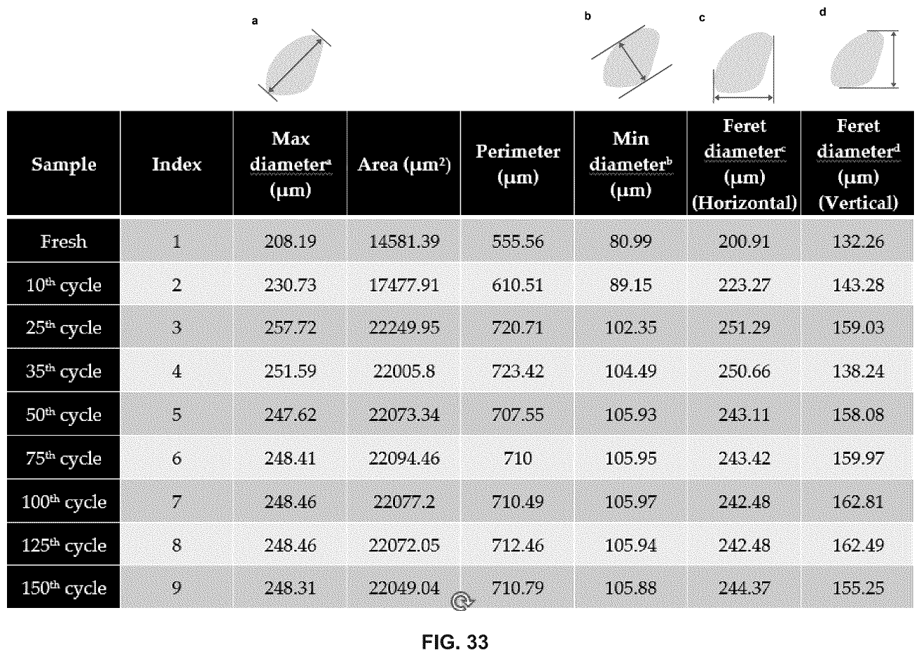

Optical microscopy and HIM were used to analyze morphological and microstructural changes in ISD during thermal and hydration cycling. A small ISD crystal was kept on a microscopic slide and cycled using the same parameters as powdered ISD. Optical microscopy images after different numbers of cycles are shown in FIG. 28C. They reveal that ISD's initially transparent and well-stacked crystalline morphology became progressively opaque. Increasing light scattering indicates morphological changes such as cracks and pore formation, and a loss of preferred orientation, which was evident in the PXRD patterns of FIG. 20D. It is evident from FIG. 28C that ISD crystals show macroscopic volume expansion across cycling due to the formation of pores presumably formed during the dehydration process. The crack formation due to this linear volume expansion initiates by the 25^{th} cycle and becomes more pronounced, propagating until approximately the 75^{th} cycle. The crystal area increased by nearly 50% by the 25^{th} cycle. Minor morphological changes continued to occur up to 75^{th} cycle beyond which only negligible changes were observed (FIG. 33). The crystal structure of the ISD crystal remains unchanged despite undergoing significant volume expansion, as evident from FIG. 20D. This suggests that volume expansion during thermal and hydration cycling generates localized stress within the crystals, leading to microstructural changes without affecting the overall structure of the ISD. As suggested earlier, the ISD to ISA transition may occur via the realignment of structure from a true racemate in ISD to a racemic conglomerate in ISA. These repeated structural changes, combined with pore formation due to outgoing water molecules, further promote the formation of large voids for accommodating the conformational dynamics during ISD to ISA interconversion.

High-resolution HIM images in FIG. 28D depict the gradual evolution of surface morphology across 150 hydration-dehydration cycles. Small pores and microcracks can be observed in samples after 25 cycles, consistent with optical microscopy observations that increase in number and size with successive cycling. These pores form due to the removal of water molecules during dehydration and to accommodate internal stress due to volume expansion from hydration. Coalescence of numerous small pores with increasing cycling is also evident in widening the pore sizes, sometimes resembling microcracks. High-magnification images of ISA in FIG. 28E depict a typical layered morphology of ibuprofen crystals. Pore size increases from 100-200 nm at 25 cycles to over 500 nm after 150 cycles, confirming that water movement, internal stress, and reversible conformational changes are absorbed at the pores. The increasing depth and breadth of pore formation with cycling suggest that these pores relieve stress due to volume changes but also act as stress concentration points around the pore boundaries. The gradual expansion of pore boundaries, relieving stress, facilitates further volume expansion, unobstructed movement of water, and rapid conformation changes during hydration and dehydration.

While indicative of material degradation, the presence of surface defects also offers potential benefits. Moderate porosity improves water transport kinetics by expanding surface area and diffusion channels, enhancing hydration-dehydration efficiency. However, excessive pore and crack formation might compromise structural integrity and mechanical strength, posing challenges in optimizing performance without significant degradation. Minimal pulverization and consistent retention of energy storage and release capacity during cycling offer significant advantages in applications that demand long-term system efficiency.

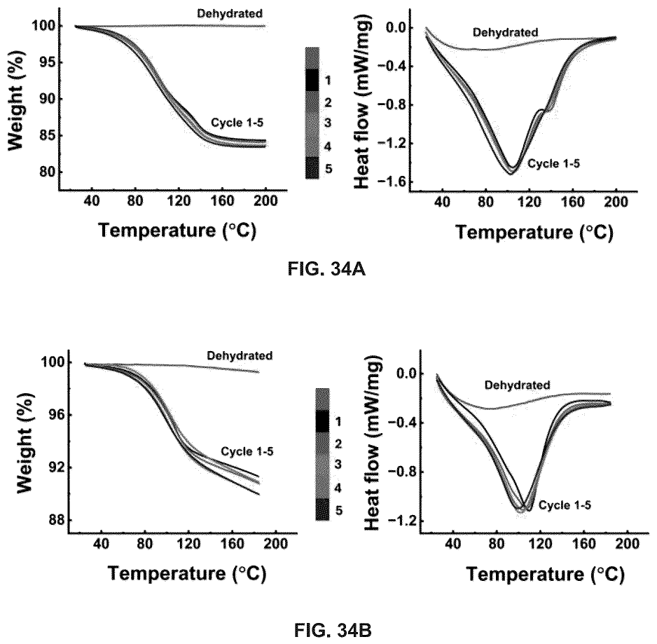

The experiments and analysis set forth herein opens a new material discovery pipeline by demonstrating that complex organic/pharmaceutical hydrates are a promising class of materials for TCES applications. It is believed that OSH materials with reversible hydration behavior can demonstrate exceptional versatility owing to their immense structural and chemical diversity and well established and scalable manufacturing processes. The hydrophobic backbone of OSH materials reduces deliquescence challenges faced by inorganic salt hydrates, while their versatile chemical structure allows significant tunability of the structure and functional groups for tuning thermal energy storage capacity, discharge time, and self-discharge properties. To further validate both interpolated and extrapolated embodiments of the invention two more compounds representing different classes of pharmaceutical hydrates, viz. channel (cromolyn sodium hydrate, CSH) and ion-associated (nedocromil sodium hydrate, NSH) hydrates were tested for their TCES potential. The TGA/DSC plots of FIG. 34A show the experimental results from testing cromolyn sodium hydrate (CSH) while the corresponding plots of FIG. 34B shows the experimental results from testing nedocromil sodium hydrate (NSH). Slight profile changes, such as the conversion of two-step dehydration into one step in cromolyn and the additional water storage plus low-temperature shift in DSC for nedocromil, may be attributed to minor structural adjustments due to cycling. Cromolyn sodium is classified as a channel hydrate, where the water molecules form large, continuous channels along specific crystallographic axes, allowing for significant water storage within the lattice. However, water molecules are stored in these channels by relatively weak hydrogen bonds, resulting in lower dehydration temperatures, while movement of molecules within the channels leads to large volumetric changes. The TGA/DSC plots of CSH depict a reversible mass loss of around 16.5±1% (loss of 5-6 water molecules) when heated to 200° C. and an energy storage capacity as high as 400±10 J/g. The water molecules are lost in a two-step process as depicted by two endothermic peaks that demonstrate reversible hydration at 25° C. and 90% RH for 1 h. Similarly, NSH, a metal ion-associated hydrate, stores water molecules that are strongly coordinated to metal ions, such as sodium or zinc, forming stable hydration complexes. These water molecules are not simply hydrogen-bonded to the lattice but are directly linked to the metal ions, making the water loss process more complex and energy-intensive. NSH can be dehydrated at an optimum temperature range of up to 185° C., resulting in about 10.5±1% mass loss during dehydration, corresponding to the removal of three water molecules. The associated DSC profile exhibited a sharp endothermic peak (185-200 J/g), reflecting its energy storage capacity and high operating temperature range. Rehydration of NSH at 25° C. and 40% RH for 1 h allowed the sample to regain its hydrated state. Both compounds showed stable cycling behavior for up to the 5 cycles that were tested.

Further Details on Materials and Methods Associated with the Additional Examples and Experiments Set Forth Above:

### Materials:

Ibuprofen Sodium Salt (CAS-No: 31121-93-4) was purchased from Sigma-Aldrich Corporation (St. Louis, MO). It has a molecular formula of C₁₃H₁₇NaO₂ and a molecular weight of 228.26 g/mol. The salt exists as a racemic mixture of (R, S)-(±)-sodium 2-(4-isobutylphenyl) propionate, containing both enantiomers of the compound. Upon exposure to atmospheric moisture at room temperature, the salt readily transforms into Ibuprofen Sodium Dihydrate (ISD), with the molecular formula C₁₃H₁₇NaO₂·2H₂O and a molecular weight of 264.29 g/mol. The anhydrous form of ibuprofen sodium salt (ISA) was obtained by heating ISD in an oven at 100° C. for 1 hour and 30 minutes. Once dehydrated, the material was stored under vacuum to maintain its anhydrous state and prevent rehydration.

Strontium chloride hexahydrate (CAS-No: 10025-70-4, molecular weight 266.62 g/mol), and Cromolyn Sodium Salt (CAS-No: 15826-37-6, molecular weight 146.11 g/mol) were purchased from Sigma-Aldrich Corporation (St. Louis, MO). Calcium oxalate monohydrate (CAS-No: 5794-28-5, molecular weight 146.11) was purchased from Thermo Fisher Scientific (Ward Hill, MA). Nedocromil Sodium Salt (CAS-No: 69049-74-7, molecular weight 415.3 g/mol) was purchased from A2B Chem (San Diego, CA).

### Simultaneous Thermal Analysis:

Simultaneous thermal analysis (STA) was performed using a NETZSCH STA 449 F3 Jupiter instrument equipped with a copper furnace. Both the mass changes and heat flow during heating were measured. This setup combines Thermogravimetric Analysis (TGA) and Differential Scanning calorimetry (DSC), allowing for the simultaneous detection of thermal events such as dehydration, mass loss, and melting transitions.

The instrument was calibrated with standardized weights and melting point reference materials (Hg, Ga, In, Sn, Bi, and Zn) to ensure accurate measurements of temperature and heat flow. Samples were placed in aluminum oxide (Al2O3) crucibles with a volume of 85 μl and covered with a pierced lid. The sample mass was maintained at approximately 15 mg. For reference, an empty alumina crucible with a pierced lid was used.

During the experiment, the samples were heated from 25° C. to 250° C. under a continuous nitrogen gas flow of 60 mL/min. A constant heating rate of 10° C./min was applied to ensure uniform temperature distribution throughout the sample. The TGA monitored the mass changes of the sample during heating, focusing on dehydration processes, while the DSC captured the associated heat flow, detecting endothermic events such as dehydration and melting. Netzsch Proteus thermal analysis software was used to analyze the obtained data.

### Humidity-Controlled Calorimetry:

The energy released during rehydration was investigated using a Setaram Calvet C80 calorimeter coupled with a Flexiwet Humidity Generator, which enabled precise control over both temperature and humidity conditions. This setup was crucial for accurately assessing the energy dynamics associated with the hydration and dehydration of the material, ensuring that all measurements reflected the true thermal behavior under controlled environmental conditions.

For measurement of dehydration energy, a 100 mg sample of ISD was loaded into the calorimeter. The sample was heated from 25° C. to 120° C. at a rate of 0.1° C./min under a nitrogen gas flow of 75 mL/min with a controlled relative humidity (RH) of 40%. This ensured that complete dehydration was achieved and the calorimeter recorded the absolute maximum energy absorbed during the dehydration process. Following this dehydration ramp, the sample was held at 120° C. under a nitrogen flow of 75 mL/min, 5% RH for 2 hours. The sample was then cooled down to 25° C., and once the temperature and heat signal stabilized, the relative humidity of the nitrogen flow (75 mL/min) was increased from 5% to 90% RH. The temperature and heat signals were recorded until they returned to the baseline after the rehydration process was fully completed.

### In-Situ Infrared Spectroscopy (ATR-FTIR):

To gain a deeper understanding of the reversible dehydration and rehydration mechanisms and to confirm the stability of chemical bonds during these processes, in-situ Attenuated Total Reflectance-Fourier Transform Infrared (ATR-FTIR) Spectroscopy was employed. The FTIR experiments were conducted using a Bruker Alpha II-P ATR module equipped with an inbuilt heating capability and a pressure applicator to ensure consistent contact between the sample and the ATR crystal. ISD was subjected to controlled heating from 25° C. to 110° C. in 10° C. intervals. At each temperature step, the sample was stabilized for 5 minutes to ensure uniform heating, and spectra were recorded across the 4000 cm⁻¹ to 400 cm⁻¹ wavelength range.

To assess the chemical stability during rehydration, the sample was then cooled back to room temperature (approximately 22° C.) and exposed to ambient humidity levels. Spectra were collected at regular intervals from 5 minutes to 5 hours, during the rehydration process.

### Powder X-Ray Diffraction (PXRD) & In-Situ PXRD:

The crystal structure stability and changes occurring during and after the dehydration and hydration processes were analyzed using in-situ and ex-situ PXRD.

Ex-situ PXRD was conducted using Rigaku Miniflex 600 diffractometer equipped with a Cu Kα radiation source. The diffractometer was enclosed within a glovebox maintained under a nitrogen atmosphere to prevent environmental contamination and maintain control over the sample's atmosphere. Samples were prepared by grinding the bulk material into a fine powder to ensure homogeneity and uniform particle size. The powder was then spread evenly on a sample holder, ensuring consistent packing height and density. Dehydrated samples were prepared inside the glovebox under dry nitrogen conditions with a low relative humidity (<5% RH). Hydrated samples were prepared with the glovebox and diffractometer setup open to atmospheric room temperature and moisture conditions. Diffraction patterns were collected over a 2θ range of 3 to 70° 2θ with a step size of 0.01°, and a scan rate of 10° per minute.

For the lattice cell parameter calculations of FIG. 17, the fresh ISD and ISD-150 sample patterns were collected from powders packed into a zero-background well plate inside a domed atmosphere protective holder using a Rigaku SmartLab SE diffractometer. The instrument employed Bragg-Brentano geometry with a Cu X-ray source (λ=1.5418 Å), a variable divergence slit, and a high-speed D/teX Ultra 250 1D detector. Patterns were collected between 2 and 100° 2θ at intervals of 0.01° 2θ, scanning at 2° 2θ per minute. Refinement of cell parameters was performed by the Rietveld method using TOPAS (v6, Bruker AXS), using the structure published by Zhang et al (Zhang, Y. and D. J. W. Grant, Similarity in structures of racemic and enantiomeric ibuprofen sodium dihydrates. Acta Crystallographica Section C, 2005. 61(9): p. m435-m438). The atomic coordinates were fixed, and only the scale factor, cell parameters, crystallite size, and a preferred orientation correction were refined.

In-situ PXRD was employed to monitor real-time structural changes during the dehydration and rehydration cycles using Rigaku Miniflex 600 diffractometer inside the glovebox equipped with in-situ BTS 500 heating module. The in-situ sample holder was calibrated for 1° C./min using a reference phase change material (KNO₃), and the following ISD sample data were processed accordingly. For the dehydration process, the sample was heated from 35° C. to 125° C. using a BTS 500 heating module with a controlled ramp rate of 1° C./min. During this temperature ramping, continuous X-ray diffraction patterns were taken over a 2θ range of 3° to 45°, a step size of 0.01°, and a scan rate of 10° per minute. Once the sample reached 125° C., it was held at this temperature for 30 minutes to ensure complete dehydration.

For the rehydration process, the sample was cooled to below 35° C., and humidified nitrogen (set at 40% RH, 25° C., with a flow rate of 150 mL/min) was introduced directly into the BTS chamber with the help of a Flexiwet 200 humidity generator using a gas line connection without opening the glovebox. This allowed the sample to rehydrate under controlled conditions, with diffraction patterns continuously collected at the same rate as during the dehydration process.

### MAS-NMR Measurements:

MAS-NMR experiments for ¹H, ¹H-¹³C cross polarization (CP), and ²³Na were conducted at 14.1 T (600 MHz ¹H) with a Bruker Avance IIIHD console and using a 2.5 mm HXY probe with 30 KHz MAS rate and temperature regulation to 298.2 K from a BCU II. Samples included both hydrated ISD and anhydrous ISA, combined with 1-cycle and 150-cycle versions of the same. Pulse widths were calibrated from the reference standards (adamantane for ¹H and ¹³C; 1 M NaCl for ²³Na), with 2.4 us for ¹H and 3.5 us (solids π/2) for ²³Na. A recycle delay of 30 s was used to acquire the ¹H MAS-NMR 1D spectra, with 16 scans and a 23 ms acquisition time. For ²³Na, 2.5 s of recycle delay was used with 512 scans and a 20 ms acquisition time; a π/10 tip angle was used to ensure sufficient excitation bandwidth. For the ¹H-¹³C CPMAS experiments, the MAS rate was reduced to 10 KHz, and the Hartmann-Hahn match condition was determined empirically on the samples by sequentially arraying the X channel power with fixed ¹H (77 kHz radiofrequency), followed by optimization of the contact time (4000 us the approximate optimum for all samples examined). A recycle delay of 4 s with 1k scans was employed for all ¹H-¹³C CPMAS experiments, and all acquisitions for these were performed in a 53 kHz radiofrequency SPINAL-64 decoupling field. All spectral processing and ²³Na quadrupolar fitting were performed with ssNake v. 1.5 (van Meerten, S. G. J., W. M. J. Franssen, and A. P. M. Kentgens, ssNake: A cross-platform open-source NMR data processing and fitting application. Journal of Magnetic Resonance, 2019. 301: p. 56-66).

### Optical Microscopy

Optical microscopy was employed to observe surface morphology and track potential degradation phenomena, such as cracking or pulverization, across the cycling process. High-resolution images were captured using a Keyence VHX-7000 digital microscope to document visible changes in particle size and surface texture, comparing cycled samples to uncycled baseline samples to investigate structural alterations potentially caused by cycling. The morphological parameters, such as area, perimeter, maximum & minimum diameter, and Feret diameter (horizontal & vertical), were measured using the in-built auto-area measurement function without any additional processing.

### Helium Ion Microscopy

Helium Ion Microscopy (HIM) was applied specifically for detailed nanoscale surface imaging. HIM was selected as a complementary technique to optical microscopy, offering enhanced resolution to examine potential nanoscale features and observe fine structural changes that may have emerged during the cycling process. High-resolution HIM images were acquired using the Orion Plus system, developed and marketed by Carl Zeiss Microscopy, based in Peabody, MA. Imaging was performed at normal incidence with helium ions at an energy of 30 keV. Probe currents ranging from 0.5 to 1 picoampere were utilized during image acquisition. Each image was captured in line average mode with a dwell time of 1 microsecond per pixel. Secondary electrons generated from interactions between the helium ion beam and the sample surface were detected using an Everhart-Thornley (ET) detector. To prevent charging during HIM measurements, the samples were coated with a 5 nm-thick carbon film before being transferred into the HIM.

### Hydration-Dehydration Cycling:

Building on the thermal and structural analyses from the previous sections, hydration-dehydration cycling experiments were conducted to further investigate the long-term stability and performance of the three salts. For the cycling experiments, 2 g of each salt was loaded into petri dishes. The ISD samples were placed in an oven set at 110° C. to 115° C., whereas the SCH and COM samples were placed in a muffle furnace set at 325° C. All samples were heated for 1.5 hours to ensure complete dehydration, allowing them to transform into their anhydrous forms. After dehydration, the samples were transferred to a humidity chamber (Binder KMF 115) for rehydration at 25° C. and 90% relative humidity (RH) for 1 h. This cycling process, comprising dehydration followed by rehydration, was repeated for the desired number of cycles to evaluate the material's stability and reversibility. After each dehydration and rehydration step in a cycle, weight measurements were taken to monitor the mass changes. Samples were collected after 25, 50, 75, 100, 125, and 150 cycles during the cycling experiments to track structural or thermal changes over time. These sampling points were selected to capture the material's performance and stability at various stages of cycling and to monitor any potential degradation or irreversible changes.

### Results Summary for the Additional Examples, Experiments, and Analysis

The experiments set forth herein show ISD, a pharmaceutical hydrate, as a versatile material for TCES applications. Its low dehydration temperature range (60-110° C.) and high dehydration enthalpy of up to 59.5 kJ/mol (225 J/g) of water make it particularly suitable for recovering low-grade industrial and residential waste heat, enabling the decoupling of residential and commercial space heating applications from the grid. A systematic evaluation of ISD's thermal, chemical, structural, and cycling stability demonstrated its remarkable cycling performance compared to conventional inorganic and organic salt hydrates, such as SCH and COM, which have comparable energy storage capacity.

In-situ FTIR and PXRD analyses provided details on the reversible molecular and structural transitions during dehydration-rehydration cycles, with no evidence of new phase formation, permanent structural changes, or chemical decomposition. Multimodal in-situ and ex-situ calorimetric, diffraction, and spectroscopic analysis suggested that the mechanism of energy storage and release in ISD involves concurrent reversible dehydration/hydration and phase transition (racemic compound to a racemic conglomerate). Long-term cycling experiments exhibited stable thermal behavior with high overall cycling efficiency (˜99.99%) over 150 cycles, significantly outperforming the cycling performance of SCH and COM. Surface morphology and microstructural investigations revealed the development of pores and cracks on ISD's surface during extended cycling, driven by mechanical stress from (1) repeated volumetric changes during water uptake and release, and/or (2) reversible phase transformation involving possible conformational (R and S) realignments. While excessive pore formation could compromise macro and microstructural integrity, moderate porosity was shown to enhance water transport kinetics, facilitating efficient hydration-dehydration reactions. Remarkably, ISD maintained its thermal, chemical, and structural properties for 150 cycles, highlighting its resilience for prolonged use in TES applications.

The experiments set forth herein demonstrate the tremendous potential of organic/pharmaceutical hydrates in TCES applications utilizing low-grade waste heat. It is believed that minimal purity requirements for TCES applications will be required and combined with large-scale production in traditional organic compound manufacturing facilities can provide significant material cost reductions associated with this class of materials.

### ADDITIONAL REMARKS

Any materials referenced herein or in the appendix attached hereto are incorporated herein by reference as if set forth in full. To the extent that any definitions or other teachings set forth in an appendix or in other material incorporated herein by reference contradict teachings set forth directly herein (i.e., not incorporated by reference), the order of precedence given to the definitions or other teachings are: (1) teachings set forth directly in the body of the application, then (2) teachings set forth in any appendix in the order set forth, and finally (3) teachings set forth in any incorporated material with more recent incorporated materials taking precedence over older incorporated materials.

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also to be understood that any variations of the aspects (as well as elements in embodiments or in variations of such embodiments) set forth herein represent individual and separate features that may form claim elements alone or in groups.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A thermochemical energy storage method, comprising:
(a) providing a mass comprising an organic or an organometallic hydrate/anhydrate compound with a hydrophobic backbone capable of reversibly storing water in at least one of hydrophilic channels or hydrophilic sites and releasing water wherein release of water occurs upon heating with at least a portion of heat energy stored in chemical bonds of the compound while rehydration results in an exothermic reaction releasing heat;
(b) locating the mass in a chamber;
(c) heating an at least partially hydrated mass of the compound using an external source of energy to cause at least partial dehydration of the compound so as to store energy in the chemical bonds of the compound;
(d) holding the mass in the at least partially dehydrated state until the stored energy is to be used;
(e) adding moisture to the at least partially dehydrated compound in a controlled manner to controllably release heat energy; and
(f) repeating (c)-(e) a plurality of times in an energy storage and release cycle.

2. The method of claim 1 wherein the organic or organometallic hydrate compound comprises an isolated site hydrate.

3. The method of claim 2 wherein the isolated site hydrate comprises alendronate sodium trihydrate.

4. The method of claim 1 wherein the organic or organometallic hydrate compound comprises a channel associated hydrate.

5. The method of claim 4 wherein the channel associated hydrate comprises at least one hydrate selected from the group consisting of: (1) cromolyn sodium hydrate and (2) ibuprofen sodium dihydrate.

6. The method of claim 1 wherein the organic or organometallic hydrate/anhydrate compound comprises an ion associated hydrate.

7. The method of claim 6 wherein the ion associated hydrate comprises at least one hydrate selected from the group consisting of: (1) ibuprofen sodium dihydrate and (2) nedocromil sodium.

8. The method of claim 1 wherein the heating is produced via a source selected from the group consisting of (1) a renewable energy source, (2) waste heat from an industrial process, and (3) an energy production source when production capacity exceeds demand, and (4) an energy production source used during off peak cost periods, and wherein released energy is used at a time or for a purpose selected from the group consisting of: (1) during peak cost periods to provide for space or water heating purposes thus reducing use of more costly energy for such purposes, and (2) to provide space or water heating during periods of reduced renewable energy availability.

9. The method of claim 1 wherein the hydrate/anhydrate compound comprises a material that undergoes a reversable solid-to-solid phase change during dehydration and hydration and provides for additional energy storage and release in the form of physical material change in addition to providing for energy storage in the form of chemical bonds.

10. A thermochemical energy storage method, comprising:
(a) providing a mass of a medium including an organic or an organometallic hydrate/anhydrate compound with a hydrophobic backbone capable of reversibly storing water at at least one of hydrophilic channels or hydrophilic sites and releasing water wherein release of water occurs upon dehydration with the chemical bonds of the drier compound storing more energy than a more hydrated form of the compound while rehydration results in an exothermic reaction releasing heat;
(b) locating the mass in a chamber;
(c) dehydrating an at least partially hydrated mass of the compound to cause at least partial removal of water from the compound so as to store energy in the chemical bonds of the compound;
(d) holding the mass in the at least partially dehydrated state until the stored energy is to be used;
(e) adding moisture to the at least partially dehydrated compound in a controlled manner to controllably release heat energy; and
(f) repeating (c)-(e) a plurality of times in an energy storage and release cycle.

11. The method of claim 10 wherein the organic or organometallic hydrate compound comprises an isolated site hydrate.

12. The method of claim 11 wherein the isolated site hydrate comprises alendronate sodium trihydrate.

13. The method of claim 10 wherein the organic or organometallic hydrate compound comprises a channel associated hydrate.

14. The method of claim 13 wherein the channel associated hydrate comprises at least one hydrate selected from the group consisting of: (1) cromolyn sodium hydrate and (2) ibuprofen sodium dihydrate.

15. The method of claim 10 wherein the organic or organometallic hydrate/anhydrate compound comprises an ion associated hydrate.

16. The method of claim 15 wherein the ion associated hydrate comprises at least one hydrate selected from the group consisting of: (1) ibuprofen sodium dihydrate and (2) nedocromil sodium.

17. The method of claim 10 wherein dehydration occurs via heating.

18. The method of claim 10 wherein dehydration occurs via exposure of the compound to a dry gas or dry relative humidity gas where the moisture content of the gas is sufficiently low to extract water from the compound.

19. The method of claim 10 wherein the hydrate/anhydrate compound comprises a material that undergoes a reversable solid-to-solid phase change during dehydration and hydration and provides for additional energy storage and release in the form of physical material change in addition to providing for energy storage in the form of chemical bonds.

20. A thermochemical energy storage method, comprising:
(a) providing a medium comprising at least one compound selected from the group consisting of: (1) alendronate sodium trihydrate, (2) cromolyn sodium, (3) ibuprofen sodium dihydrate, and (4) nedocromil sodium wherein the compound is capable of reversibly storing water and releasing water wherein release of water occurs upon dehydration of the compound with energy stored in chemical bonds of the compound while rehydration results in an exothermic reaction releasing heat energy;
(b) locating a partially hydrated mass of the medium in a chamber;
(c) dehydrating the at least partially hydrated mass to cause at least partial dehydration of the mass so as to store energy in the chemical bonds of the compound;
(d) holding the compound in an at least partially dehydrated state until the stored energy is to be used;
(e) adding moisture to the at least partially dehydrated compound to release heat energy; and
(f) repeating (c)-(e) a plurality of times in an energy storage and release cycle.
